(19) United States
(12) Patent Application Publication
(10) Pub. No.: US 2005/0078177 A1
(43) Pub. Date: Apr. 14, 2005

(54) Advertisement display system and automatic transaction apparatus for use therein

(76) Inventor: Sayuri Gotanda, Tokyo (JP)

Correspondence Address: RABIN & Berdo, PC, 1101 14TH STREET, NW, SUITE 500, WASHINGTON, DC, 20005, US

(21) Appl. No.: 10/879,427

(22) Filed: Jun. 30, 2004

(30) Foreign Application Priority Data
Oct. 8, 2003 (JP) JP2003-350090

(51) Int. Cl. H04N 7/18; H04N 7/00; G06F 13/00; H04N 9/47

(52) U.S. Cl. 348/114; 725/32; 725/43; 725/34

(57) ABSTRACT

An advertisement display system has: an automatic transaction apparatus having a display screen; a monitor set near the automatic transaction apparatus; an advertisement control apparatus which controls an advertisement display of the automatic transaction apparatus and the monitor; and an advertisement operation server which holds advertisement information requested by an advertiser. The advertisement control apparatus receives the advertisement information and an advertisement display table describing its display schedule from the server, distributes them to the automatic transaction apparatus, displays the advertisement information, and displays the advertisement information onto the monitor on the basis of the advertisement display table. It is possible to advertise generally to the customers who visit a financial institution or the like.

### BACKGROUND OF THE INVENTION

1. Field of the Invention

The invention relates to an advertisement display system for displaying an advertisement to an automatic transaction apparatus set in a service office or the like of a financial institution or the like and relates to the automatic transaction apparatus which is used in such a system.

2. Related Background Art

In a conventional advertisement display system, while a management computer is executing a process requested by an automatic cash transaction apparatus which transacts business with customers, advertisement data according to attributes of the customer such as account balance, hobby, and the like of the customer is extracted and transmitted to the automatic cash transaction apparatus, an advertisement is displayed onto a display screen of the automatic cash transaction apparatus during a process waiting time of the customer, the number of points of the displayed advertisement is summed, and an advertiser is charged an advertisement fee (for example, refer to JP-A-2003-228309 (mainly, page 3, FIG. 1)).

However, in the foregoing conventional technique, since the advertisement according to the attributes of the customer is displayed onto the monitor screen of the automatic cash transaction apparatus during the process waiting time of the transaction by the automatic cash transaction apparatus, there is such a problem that when there are a plurality of advertisements which correspond to the attributes of the customer, only one of them is displayed and the advertisements cannot be displayed according to the will of the advertiser.

There is also such a problem that since only the customer who transacts business sees the advertisement, the advertiser cannot advertise generally to the customers who visit a financial institution or the like.

### SUMMARY OF THE INVENTION

The invention is made to solve the foregoing problems and it is an object of the invention to provide an advertisement display system which can advertise generally to the customers who visit a financial institution or the like.

According to the present invention, there is provided an advertisement display system comprising:
an automatic transaction apparatus having a display screen;
a monitor set near the automatic transaction apparatus;
an advertisement control apparatus which controls an advertisement display of the automatic transaction apparatus and the monitor; and
an advertisement operation server which holds advertisement information requested by an advertiser,
wherein the advertisement control apparatus receives the advertisement information and an advertisement display table describing a display schedule of the advertisement information from the advertisement operation server, distributes the advertisement information and the advertisement display table to the automatic transaction apparatus, displays the advertisement information, and displays the advertisement information onto the monitor on the basis of the advertisement display table.

Further, according to the present invention, there is also provided an advertisement display system comprising:
an automatic transaction apparatus having a display screen;
a monitor set near the automatic transaction apparatus;
an advertisement control apparatus which controls an advertisement display of the automatic transaction apparatus and the monitor; and
an advertisement operation server which holds advertisement information requested by an advertiser,
wherein the advertisement control apparatus receives the advertisement information and an advertisement display table describing a display schedule of the advertisement information from the advertisement operation server, previously distributes the advertisement information to the automatic transaction apparatus, manages an advertisement time zone during which the advertisement information is displayed to the automatic transaction apparatus on the basis of the advertisement display table, and displays the advertisement information onto the monitor.

In these advertisement display systems, the advertisement display table includes a plurality of display timing at which the advertisement information is displayed to the automatic transaction apparatus. Then, the plurality of display timing is “before transaction selection”, “under-the-process”, and “continuous”.

In one case, a management server is provided for a financial institution or the like and the management server records the number of displaying times of the advertisement information displayed during the process of the automatic transaction apparatus.

In other case, a management server is provided for a financial institution or the like, reaction collect buttons are provided for the advertisement information which is displayed to the automatic transaction apparatus, and the management server records a type of the reaction collect button depressed by a customer during a transaction of the automatic transaction apparatus.

In further other case, a management server is provided for a financial institution or the like, reaction collect buttons are provided for the advertisement information which is displayed to the automatic transaction apparatus, and the management server records the number of displaying times of the advertisement information displayed during the process of the automatic transaction apparatus and also records a type of the reaction collect button depressed by a customer during a transaction of the automatic transaction apparatus.

Further, the management server stores the advertisement display table of the automatic transaction apparatus and campaign information of the financial institution or the like, and when the management server receives the existence of the customer of the automatic transaction apparatus, the management server refers to the advertisement display table and transmits the campaign information related to the advertisement information to the automatic transaction apparatus, and the automatic transaction apparatus displays both of the advertisement information and the campaign information.

Further, in these advertisement display system, the advertisement control apparatus receives an instruction for interrupting and restarting the display of the advertisement information and specific advertisement information.

Further, according to the present invention, there also is provided an advertisement display system comprising:
an advertisement operation server which holds advertisement information requested by an advertiser;
an advertisement control apparatus which controls an advertisement display of a service office;
a monitor which is controlled by the advertisement control apparatus and which displays the advertisement information; and
an automatic transaction apparatus which is set near the monitor, has a display screen, and is connected to the advertisement control apparatus,
wherein the automatic transaction apparatus receives at least a part of the advertisement information that is received by the advertisement control apparatus from the advertisement operation server and displayed onto the monitor from the advertisement control apparatus and displays the advertisement information onto the display screen.

In the advertisement display system, the advertisement control apparatus receives an advertisement display table and the advertisement information from the advertisement operation server, the advertisement information is displayed onto the monitor on the basis of the advertisement display table, and when the advertisement information is displayed onto the display screen, the advertisement display table including the part of the advertisement information to be displayed onto the monitor is received together with the advertisement information and the advertisement information is displayed.

Further, in the advertisement display system, the advertisement information is displayed during a process waiting time of a customer and a button to return to a transaction process is displayed on the display screen.

Further, in the advertisement display system, when there are a plurality of the advertisement information, advertisement select buttons to select the advertisement information are displayed on the display screen so as to be selectable.

Further, in the advertisement display system, when the advertisement information is displayed, reaction collect buttons to collect reactions of customers are displayed on the display screen so as to be selectable.

Further, in the advertisement display system, when the reaction collect button is depressed, the customer is allowed to input personal information.

Thus, according to the invention, there are obtained such effects that similar advertisements can be displayed to the monitor and the automatic transaction apparatus, advertisement information can be displayed not only to the customer who transacts business by the automatic transaction apparatus but also to the customers who wait for a transaction, and it is possible to advertise generally to the customers who visit a financial institution or the like.

The above and other objects and features of the present invention will become apparent from the following detailed description and the appended claims with reference to the accompanying drawings.

### BRIEF DESCRIPTION OF THE DRAWINGS

FIG. 1 is a block diagram showing a construction of a system in an embodiment 1;

FIG. 2 is a block diagram showing an advertisement control apparatus in the embodiment 1;

FIG. 3 is a block diagram showing an automatic cash transaction apparatus in the embodiment 1;

FIG. 4 is a table showing an example of a construction of an accumulation table of the number of displaying times in a use information storing area in the embodiment 1;

FIG. 5 shows a constructional example of advertisement display tables in a monitor and a lobby display apparatus in the embodiment 1;

FIG. 6 shows a constructional example of an advertisement display table in the automatic cash transaction apparatus in the embodiment 1;

FIG. 7 is a flowchart showing an advertisement control process of the advertisement control apparatus in the embodiment 1;

FIG. 8 shows a display example of a display screen for designating display stop in the embodiment 1;

FIG. 9 shows a display example of the display screen of a monitor advertisement in the embodiment 1;

FIG. 10 is a flowchart showing an advertisement displaying process of the automatic cash transaction apparatus in the embodiment 1;

FIG. 11 shows a display example of the display screen of a pretransaction advertisement in the embodiment 1;

FIG. 12 shows an example of a continuous advertisement display of a transaction selecting display screen in the embodiment 1;

FIG. 13 shows an example of a continuous advertisement display of an amount inputting display screen in the embodiment 1;

FIG. 14 shows a display example of an under-the-process advertisement display screen in the embodiment 1;

FIG. 15 shows a display example of the display screen of another monitor advertisement in the embodiment 1;

FIG. 16 shows a display example of a continuous advertisement display column and an under-the-process advertisement display column in another form in the embodiment 1;

FIG. 17 shows an constructional example of an advertisement display table in the automatic cash transaction apparatus in another form in the embodiment 1;

FIG. 18 is a block diagram showing a construction of a system in an embodiment 2;

FIG. 19 is a flowchart showing an advertisement control process of an advertisement control apparatus in the embodiment 2;

FIG. 20 is a flowchart showing an advertisement displaying process of an automatic cash transaction apparatus in the embodiment 2;

FIG. 21 is a table showing an example of a construction of an accumulation table of the number of displaying times in a use information storing area in the embodiment 2;

FIG. 22 shows a display example of a continuous advertisement display column and an under-the-process advertisement display column in the embodiment 2;

FIG. 23 shows an example of a construction of a customer reaction collection table in the embodiment 2;

FIG. 24 shows an constructional example of another customer reaction collection table in the embodiment 2;

FIG. 25 shows a display example of a personal information input display screen (in the case under consideration for purchase) in the embodiment 2;

FIG. 26 shows a display example of another continuous advertisement display column and another under-the-process advertisement display column in the embodiment 2;

FIG. 27 is a block diagram showing a construction of a system in an embodiment 3;

FIG. 28 is a flowchart showing an advertisement displaying process of an automatic cash transaction apparatus in the embodiment 3; and

FIG. 29 shows a display example of an under-the-process advertisement display screen of campaign information in the embodiment 3.

### DETAILED DESCRIPTION OF THE PREFERRED EMBODIMENTS

Embodiments of an advertisement display system according to the invention will be described hereinbelow with reference to the drawings.

### Embodiment 1

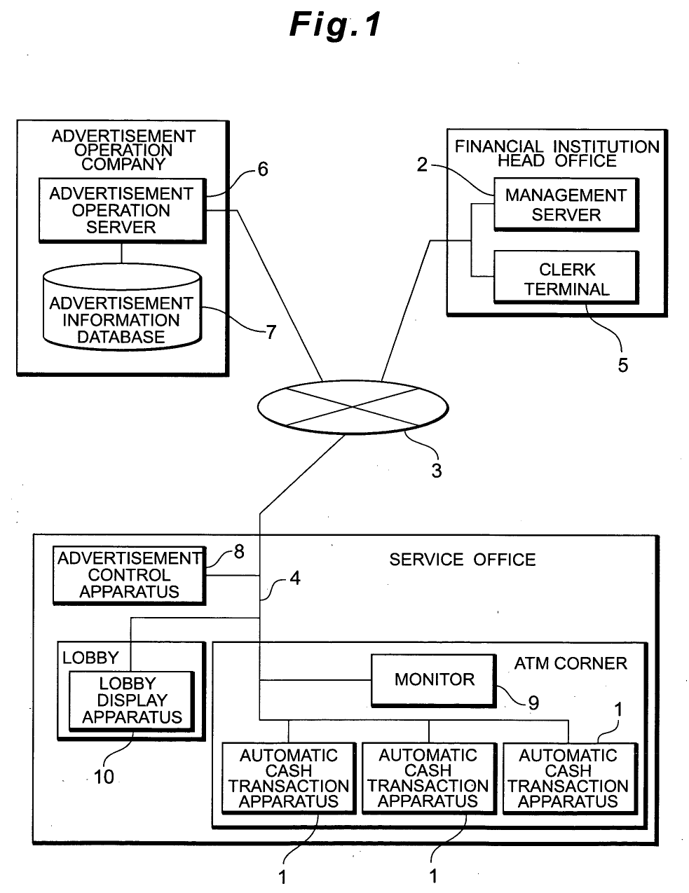

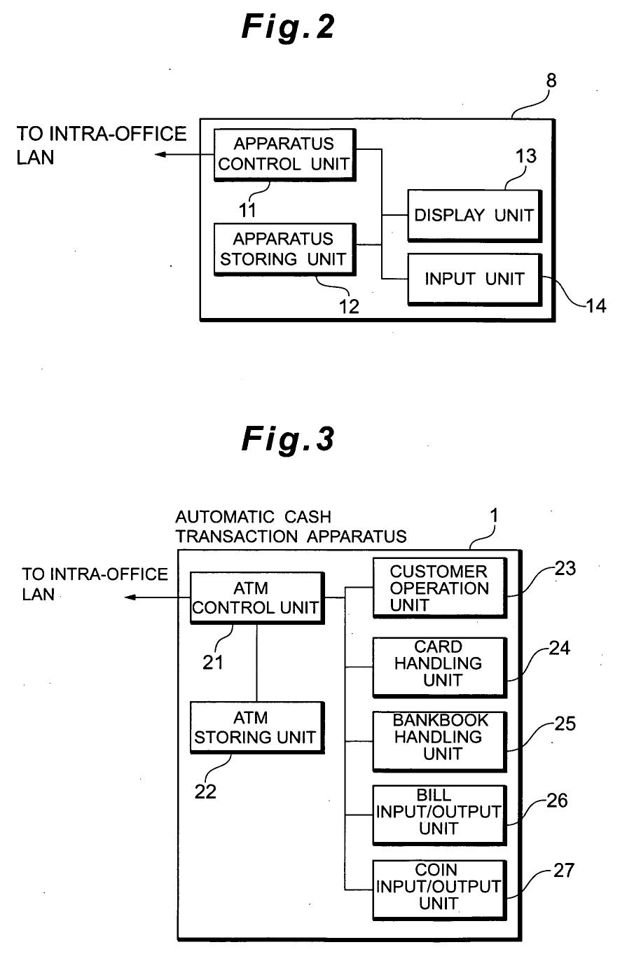

FIG. 1 is a block diagram showing a construction of the system in an embodiment 1. FIG. 2 is a block diagram showing an advertisement control apparatus in the embodiment 1. FIG. 3 is a block diagram showing an automatic cash transaction apparatus in the embodiment 1.

In FIG. 1, reference numeral 1 denotes an automatic cash transaction apparatus as an automatic transaction apparatus. The automatic cash transaction apparatus 1 is set at an ATM corner or the like of a branch of a financial institution such as a bank or the like, the Japan Postal Services Corporation, a convenience store, and the like (hereinafter, each of them is referred to as a financial institution or the like) or a service office of a post office or the like and automatically performs a spot transaction with the customer.

Reference numeral 2 denotes a management server set in the head office of the financial institution or the like. The management server is connected to an intra-office LAN (Local Area Network) 4 of the service office through a communication line 3 such as telephone line, dedicated line, Internet, or the like. The management server receives advertisement use notifications regarding advertisement information from the automatic cash transaction apparatuses 1 connected via the intra-office LAN 4, records the number of receiving times, tallies up display results of the advertisement information, and the like.

Reference numeral 5 denotes a terminal of a person in charge (hereinafter, simply referred to as a clerk terminal) set in the head office of the financial institution or the like. The clerk terminal 5 is connected to the intra-office LAN 4 of the service office through the communication line 3 and used by the clerk in the head office to operate and input interest rate, exchange rate, and financial institution information such as handling subjects of the automatic cash transaction apparatus 1, business hours, and the like. The clerk terminal 5 is also used for confirming the advertisement information supplied from the advertiser.

Reference numeral 6 denotes an advertisement operation server which is set in an office of an enterprise different from the financial institution or the like, for example, an advertisement operation company as an advertisement agent, affiliated enterprise, or the like. The advertisement operation server 6 is connected to the intra-office LAN 4 of the service office through the communication line 3 and has an advertisement information database 7 for storing advertisement information which is supplied from the advertiser such as store, enterprise, or the like as a requester of an advertisement display in an on-line manner or by a recording medium such as a CD (Compact Disc) or the like.

Reference numeral 8 denotes an advertisement control apparatus such as a personal computer or the like. The advertisement control apparatus 8 is connected to the management server 2, the clerk terminal 5 of the person in charge, and the advertisement operation server 6 through the intra-office LAN 4 and the communication line 3 and can make data communication with them.

The advertisement control apparatus 8 controls the advertisement displays of the apparatuses in the whole service office, that is, the automatic cash transaction apparatuses 1 and a lobby display apparatus 10 through the intra-office LAN 4, also sends display data to a monitor 9, and directly controls its advertisement display.

The monitor 9 is a display screen constructed by a CRT, an LCD, or the like and positioned near the automatic cash transaction apparatus 1 set in the ATM corner or the like, that is, a position where the customer who waits for his turn of the transaction in the automatic cash transaction apparatus 1 (hereinbelow, such a customer is referred to as a transaction-waiting customer) can easily watch the monitor screen, for example, a position above a center portion of a plurality of automatic cash transaction apparatuses 1, on the side wall of the ATM corner, or the like. The monitor 9 displays the advertisement information to the transaction-waiting customer. In the embodiment, a large-sized monitor having a large display screen constructed in a manner similar to the monitor 9 is positioned near the automatic cash transaction apparatuses 1.

Reference numeral 10 denotes the lobby display apparatus set in a lobby of the financial institution or the like. The lobby display apparatus 10 is constructed by a combination of a display screen similar to the monitor 9 and a personal computer or the like and has a function for displaying the received advertisement information or the like.

In FIG. 2, reference numeral 11 denotes an apparatus control unit of the advertisement control apparatus 8. The apparatus control unit 11 is connected to the communication line 3, the automatic cash transaction apparatus 1 in the service office, and the like through the intra-office LAN 4, controls each section in the advertisement control apparatus 8 and the data communication, and controls the advertisement displays in the service office.

Reference numeral 12 denotes an apparatus storing unit in which a program which is executed by the apparatus control unit 11, a processing result of the apparatus control unit 11, and the like are stored.

Reference numeral 13 denotes a display unit having the display screen such as CRT, LCD, or the like.

Reference numeral 14 denotes an input unit having a keyboard, a mouse, and the like which are used by a person in charge such as clerk, maintenance person, or the like in the service office in order to input data into the advertisement control apparatus 8.

In FIG. 3, reference numeral 21 denotes an ATM control unit of the automatic cash transaction apparatus 1. The ATM control unit 21 is connected to the advertisement control apparatus 8 through the intra-office LAN 4 and connected to the management server 2 through the intra-office LAN 4 and the communication line 3. The ATM control unit 21 controls each section in the automatic cash transaction apparatus 1, executes a transaction process, advertisement display, and the like, and also makes the data communication.

Reference numeral 22 denotes an ATM storing unit in which a program which is executed by the ATM control unit 21, a processing result of the ATM control unit 21, and the like are stored.

Reference numeral 23 denotes a customer operation unit constructed by a combination of a display screen such as CRT, LCD, or the like and position signal detecting means such as a touch panel or the like. The customer operation unit 23 displays a transaction selecting display screen, a display screen to promote the customer to make a necessary procedure, a display screen of the advertisement information, or the like onto the monitor screen and receives the input from the customer by the position signal detecting means.

Reference numeral 24 denotes a card handling unit having functions for reading and writing card information recorded on a magnetic stripe of a transaction card such as a cash card or the like of the customer and printing a transaction itemized account.

Reference numeral 25 denotes a bankbook handling unit having functions for reading and writing bankbook information recorded on a magnetic stripe of an inserted bankbook of the customer and writing transaction contents or the like onto the bankbook of the customer.

Reference numeral 26 denotes a bill input/output unit having functions for receiving, identifying, counting, and storing bills inputted by the customer, ejecting bills to be paid to the customer, and returning them to him.

Reference numeral 27 denotes a coin input/output unit having functions for receiving, identifying, counting, and storing coins inputted by the customer, ejecting coins to be paid to the customer, and returning them to him.

The operation of the apparatus with the foregoing construction will now be described.

The financial institution or the like equipped with the automatic cash transaction apparatus 1 entrusts work regarding the display of the advertisement to the automatic cash transaction apparatus 1 to the advertisement operation company.

The advertisement operation company contracts with a plurality of advertisers with respect to the advertisement displays to the service offices of the financial institution or the like in specified region, district, and the like and receives the supply of the advertisement information formed by the advertisers. The advertisement operation server 6 adds file names to the advertisement information, stores and holds the advertisement information into the advertisement information database 7, and transmits the names of the advertisers and the file names to the management server 2. The management server 2 which received them records the file names in correspondence to the names of the advertisers into a storing unit (not shown) and stores them as an advertiser reference table.

Thus, a contract regarding the payment of an advertisement fee about the display of the advertisement information is concluded between the financial institution or the like and the advertiser. The advertiser pays an advertisement fee comprising: an advertisement fee which is paid for an advertisement that is displayed on a display screen of the lobby display apparatus in the service office of the financial institution or the like (hereinbelow, such an advertisement is referred to as a lobby advertisement), an advertisement which is displayed on a display screen of the monitor in the ATM corner (hereinbelow, such an advertisement is referred to as a monitor advertisement), an advertisement which is displayed on a display screen of the customer operation unit 23 before the selection of the transaction of the customer in the automatic cash transaction apparatus 1 (hereinbelow, such an advertisement is referred to as a pretransaction advertisement), and an advertisement which is displayed on a transaction display screen after the selection of the transaction (hereinbelow, such an advertisement is referred to as a continuous advertisement) (hereinbelow, such an advertisement fee is referred to as fixed advertisement rates); and an advertisement fee which is paid on the basis of the number of displaying times of an advertisement which is displayed during a process waiting time of the customer such as time during a communicating process with a host computer of an account system (not shown) for transaction, time during a book-keeping process, or the like (hereinafter, referred to as an under-the-process advertisement) (hereinafter, such an advertisement fee is referred to as variable advertisement rates).

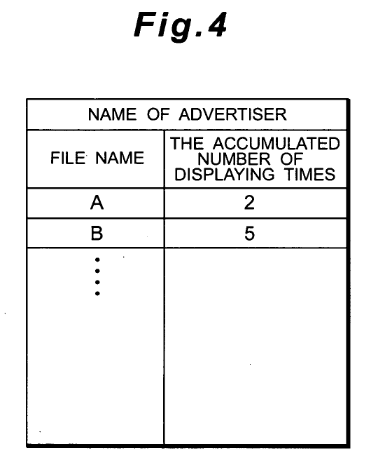

To charge for the variable advertisement rates, a use information storing area has been held in the storing unit (not shown) of the management server 2. A display number (the number of displaying times) accumulation table per advertiser shown in FIG. 4 in which a recording column to record the accumulated number of displaying times of the advertisement information on the basis of the advertisement use notification which is transmitted from the automatic cash transaction apparatus 1 is provided has been stored in the storing unit.

The financial institution or the like reads out the advertisement information of the advertiser from the advertisement information database 7 by the clerk terminal 5 through the communication line 3, previously confirms it, examines whether or not the advertisement is suitable to display for the financial institution or the like, and stores the advertisement suitable to display into the advertisement information database 7 of the advertisement operation server 6.

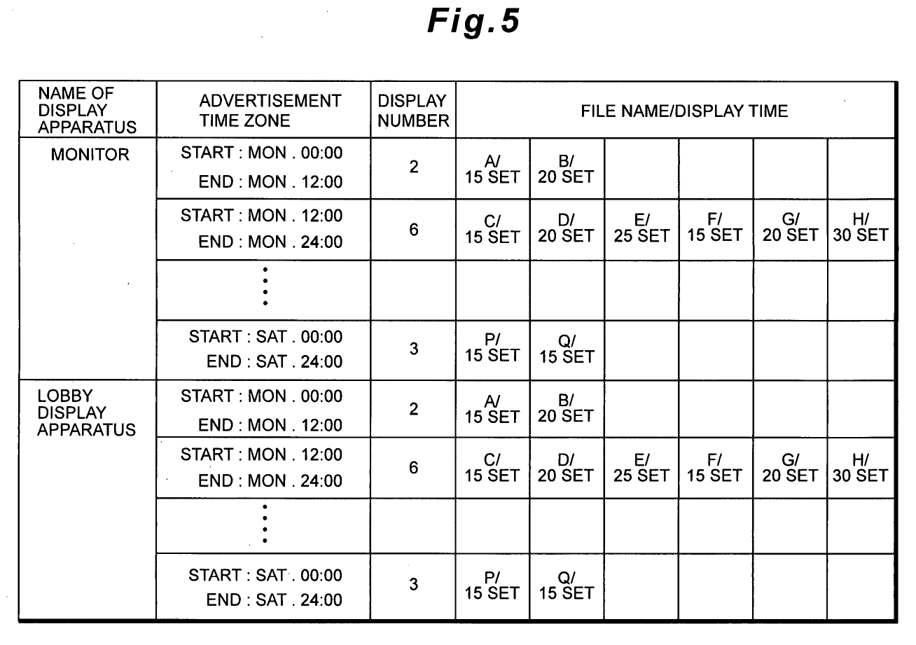

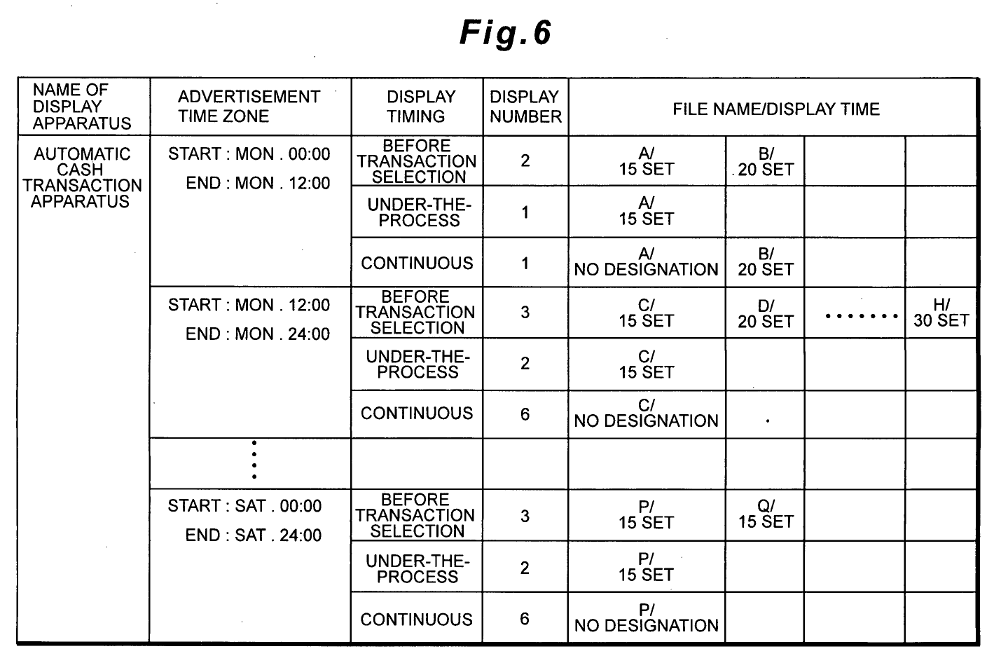

The advertisement operation server 6 forms an advertisement display table (describing a display schedule of advertisements of a predetermined period shown in FIG. 5 or 6 such as one week) per service office periodically or as necessary.

Display information in which advertisement time zones, the number of displaying times of the advertisement information which is displayed in the advertisement time zone, and the file names and display times of the advertisement information have been written in order in correspondence to the names of the display apparatuses has been written in the advertisement display tables which are used for the monitor 9 and the lobby display apparatus 10 as shown in FIG. 5.

In addition to the above information, display timing of the advertisement information which is displayed in the advertisement time zone has been written in the advertisement display table which is used for the automatic cash transaction apparatus 1 as shown in FIG. 6. The display information (the number of displaying times and the file names and the display times of the advertisement information which have been written in displaying order) has been written in correspondence to the display timing “before transaction selection”, “under-the-process”, and “continuous”, respectively.

As shown in FIGS. 5 and 6, the display information of the advertisement time zones of the display timing “before transaction selection” of the monitor 9, the lobby display apparatus 10, and the automatic cash transaction apparatus 1 is similarly written in the advertisement display tables. Those tables are constructed in such a manner that similar advertisement information is repetitively displayed in order in the monitor advertisement, lobby advertisement, and pretransaction advertisement in the same advertisement time zone.

That is, as for the advertisement information which is displayed on the monitor screen of the automatic cash transaction apparatus 1, the advertisement display tables shown in FIGS. 5 and 6 are formed in such a manner that such advertisement information is the same as the advertisement information which is displayed on the monitor screens of the monitor 9 and the lobby display apparatus 10 or at least a part of such advertisement information is included. Thus, the advertisement information united among all service offices is displayed.

The advertisement operation server 6 extracts all advertisement information corresponding to the file names in the advertisement display tables from the advertisement information database 7, attaches them to the advertisement display tables, and transmits the resultant tables to the advertisement control apparatuses 8 of the relevant service offices through the communication line 3.

On the other hand, the clerk terminal 5 set in the head office of the financial institution or the like transmits the interest rate, exchange rate, and financial institution information such as handling subjects, business hours, and the like of the automatic cash transaction apparatus 1 which were inputted by the clerk or obtained from an external database to the advertisement control apparatuses 8 of the relevant service offices through the communication line 3.

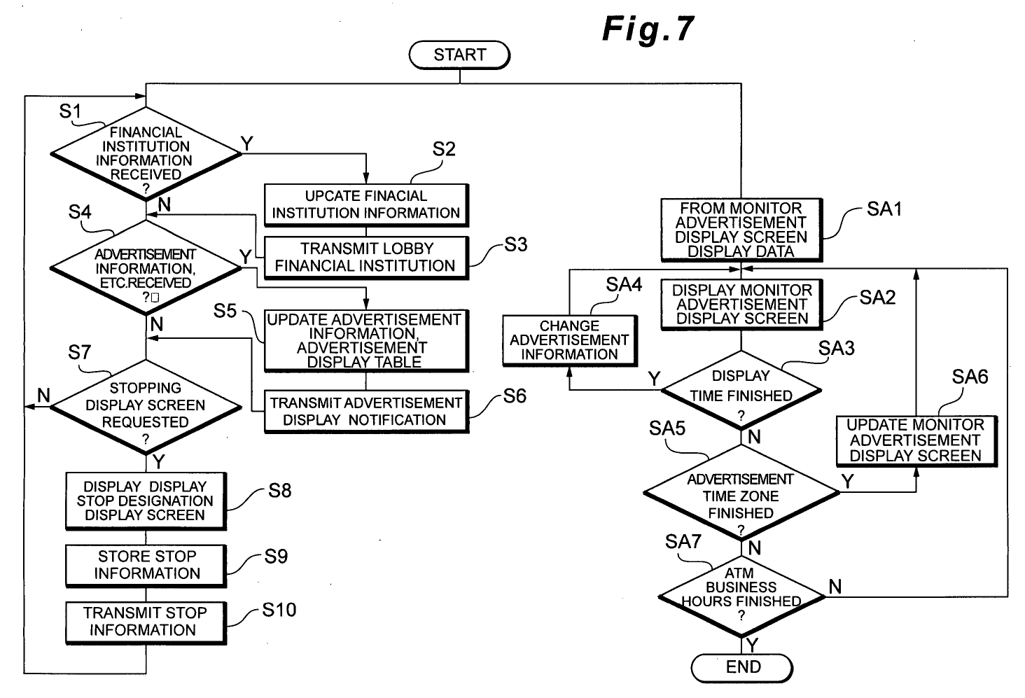

An advertisement control process of the advertisement control apparatus 8 will be described hereinbelow in accordance with processing steps starting with “S” or “SA” with reference to a flowchart shown in FIG. 7.

An advertisement display information storing area to store the advertisement information, the advertisement display tables, the financial institution information, and the like which are transmitted from the advertisement operation server 6 or the clerk terminal 5 is held in the apparatus storing unit 12 of the advertisement control apparatus 8 in the embodiment.

When a person in charge in the service office of the financial institution or the like turns on a power source of the advertisement control apparatus 8 at the opening time of the business hours (also referred to as ATM business hours) or the like of the automatic cash transaction apparatus 1 in the ATM corner, the apparatus control unit 11 of the advertisement control apparatus 8 starts the advertisement control process and executes in parallel an advertisement display information storing process shown in the processing steps starting with “S” and a monitor advertisement displaying process shown in the processing steps starting with “SA”.

S1 . . . The apparatus control unit 11 of the advertisement control apparatus 8 is in a standby mode to wait for reception of the financial institution information from the clerk terminal 5 set in the head office of the financial institution or the like. When it receives the financial institution information, the processing routine advances to step S2. When it does not receive the financial institution information, step S4 follows.

S2 . . . The apparatus control unit 11 which received the financial institution information stores the financial institution information into the advertisement display information storing area of the apparatus storing unit 12 and updates it.

S3 . . . The apparatus control unit 11 which finished the updating of the financial institution information reads out the lobby financial institution information such as interest rate, exchange rate, and the like from the updated financial institution information and transmits it to the lobby display apparatus 10, and step S4 follows.

S4 . . . The apparatus control unit 11 is in a standby mode to wait for reception of the advertisement information and the like (advertisement display tables in FIGS. 5 and 6 and the advertisement information) from the advertisement operation server 6. When it receives the advertisement information and the like, step S5 follows. When it does not receive the advertisement information and the like, step S7 follows.

S5 . . . The apparatus control unit 11 which received the advertisement information and the like stores the received advertisement display tables and the advertisement information into the advertisement display information storing area and updates them.

S6 . . . The apparatus control unit 11 which finished the updating of the advertisement information and the like transmits the advertisement display table and the advertisement information of the display apparatus name “lobby display apparatus” shown in FIG. 5 of the updated advertisement information and the like to the lobby display apparatus 10 and distributes advertisement display notifications to which the advertisement display table and the advertisement information shown in FIG. 6 have been attached to the automatic cash transaction apparatus 1. Step S7 follows.

S7 . . . When the person in charge in the service office wants to stop the advertisement display in the service office, he requests the display of a stop display screen by the input unit 14 of the advertisement control apparatus 8.

When the apparatus control unit 11 which is in the standby mode to wait for reception of the display request receives the display request, the processing routine advances to step S8. When there is no display request, the processing routine is returned to step S1 and the apparatus control unit 11 continues the above standby mode.

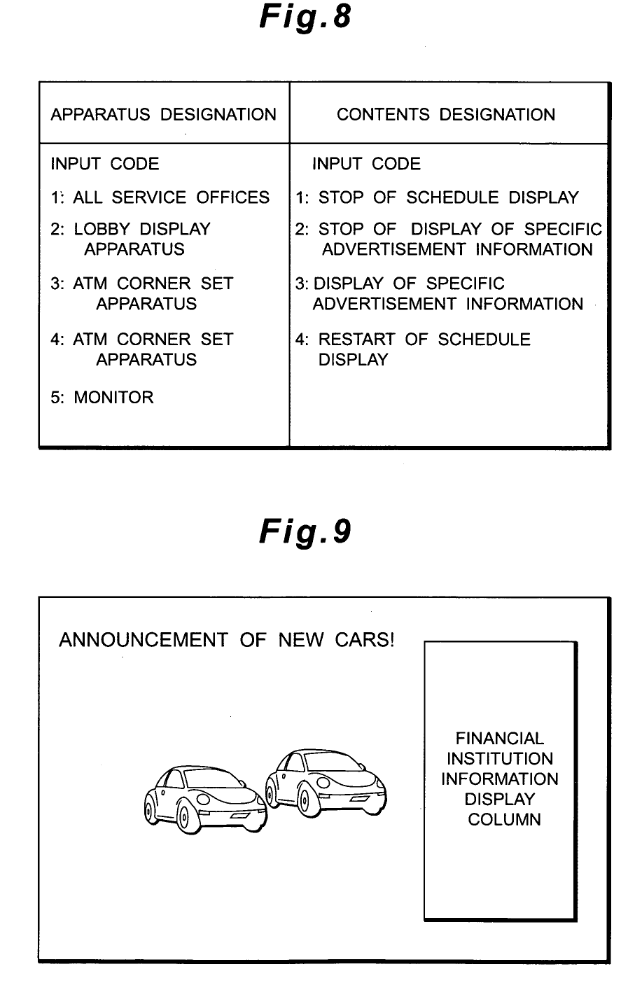

S8 . . . The apparatus control unit 11 which received the display request of the stop display screen displays a display stop designation display screen showing an apparatus designation input code, its apparatus, a contents designation input code, and its contents shown in FIG. 8 onto the display unit 13.

The person in charge combines input codes shown by numerals and inputs an apparatus in which the advertisement display is stopped and an instruction of its contents by the input unit 14.

S9 . . . . The apparatus control unit 11 which received the instruction by the input stores the received apparatus designation and the contents designation as stop information into the advertisement display information storing area.

S10 . . . The apparatus control unit 11 which finished the storage of the stop information transmits the stop information to the apparatus designated as an apparatus in which the advertisement display is stopped. For example, when the apparatus designation input code “2” has been inputted and the lobby display apparatus 10 has been designated, the stop information is transmitted to the lobby display apparatus 10.

The advertisement display information storing process of the advertisement control apparatus 8 is executed by each of the foregoing processing steps.

SA1 . . . When the power source is turned on, the apparatus control unit 11 of the advertisement control apparatus 8 confirms whether the financial institution information, the advertisement display tables, and the advertisement information have been stored in the advertisement display information storing area of the apparatus storing unit 12 or not. If those information is not stored, the apparatus control unit 11 is in the standby mode to wait for reception of those information. If those information has been stored, the apparatus control unit 11 recognizes the present time/date (time and date) by its timer function and reads out the interest rate and the ATM corner financial institution information such as handling subjects, business hours, and the like of the automatic cash transaction apparatus 1 from the financial institution information in the advertisement display information storing area of the apparatus storing unit 12. The apparatus control unit 11 also reads out the advertisement information of the first file name of the display information with reference to the display information (the number of displaying times and the file names and display times of the advertisement information written in displaying order) in the corresponding advertisement time zone of the display apparatus name “monitor” in the advertisement display table shown in FIG. 5 in the advertisement display information storing area, thereby forming display data of the monitor advertisement display screen showing columns of the advertisement information and the financial institution information display. In this case, the ATM corner financial institution information is written in the financial institution information display column.

SA2 . . . The apparatus control unit 11 sends the formed display data of the monitor advertisement display screen to the monitor 9 and displays the monitor advertisement display screen shown in FIG. 9 onto the screen of the monitor 9.

SA3 . . . The apparatus control unit 11 measures a time from the start of the display of the monitor advertisement in step SA2 by its timer function and monitors the continuation of the advertisement display. When the measured time exceeds the display time of the present advertisement information, step SA4 follows. If it is within the display time, step SA5 follows.

SA4 . . . The apparatus control unit 11 which determined that the display time of the present advertisement information has passed reads out the advertisement information of the file name written next to the file name of the presently displayed advertisement information with reference to the display information in the corresponding advertisement time zone of the display apparatus name “monitor” in the advertisement display table shown in FIG. 5 in the advertisement display information storing area, thereby forming display data of the monitor advertisement display screen in which the advertisement information has been changed, and step SA2 follows.

SA5 . . . The apparatus control unit 11 recognizes the present time/date and refers to the advertisement time zone of the display apparatus name “monitor” in the advertisement display table shown in FIG. 5 in the advertisement display information storing area. If the present time/date exceeds the advertisement time zone, step SA6 follows. If it is within the advertisement time zone, step SA7 follows.

SA6 . . . The apparatus control unit 11 which determined that the present advertisement time zone has passed reads out the ATM corner financial institution information and the advertisement information of the first file name of the display information in the advertisement time zone corresponding to the present time/date in a manner similar to step SA1, thereby forming display data of the updated monitor advertisement display screen, and step SA2 follows. In this case, if the financial institution information which is stored in step S2 has already been updated, the ATM corner financial institution information of its contents is written into a financial institution period information display column.

SA7 . . . The apparatus control unit 11 recognizes the present time/date. If the present time/date is within the ATM business hours, the processing routine is returned to step SA2 and the display of the monitor advertisement is continued. If it exceeds the ATM business hours, the advertisement control process is finished.

After that, the power source of the advertisement control apparatus 8 is turned off automatically or by the operation of the person in charge.

It is also possible to construct the system in such a manner that when the power source is turned off, the financial institution information or the like stored in the advertisement display information storing area is held by a backup power source or the like, and when the power source is turned on again, the monitor advertisement displaying process or the like by the advertisement control apparatus 8 is executed on the basis of the stored information.

By the foregoing monitor advertisement displaying process, in the advertisement time zone written in the advertisement display table during the ATM business hours of the service office of the financial institution or the like, the advertisement information of the file names to be displayed in this advertisement time zone is repetitively displayed in order on the monitor 9 in accordance with the display time.

In a manner similar to the monitor advertisement displaying process of the advertisement control apparatus 8, in the lobby advertisement displaying process of the lobby display apparatus 10 set in the lobby, a lobby advertisement display screen similar to the monitor advertisement display screen shown in FIG. 9 is displayed on the monitor screen during the advertisement time zone written in the advertisement display table during the business hours of the service office of the financial institution or the like by the timer function on the basis of the advertisement display table transmitted from the advertisement control apparatus 8. In this case, lobby financial institution information received from the advertisement control apparatus 8 is displayed in a financial institution information display column.

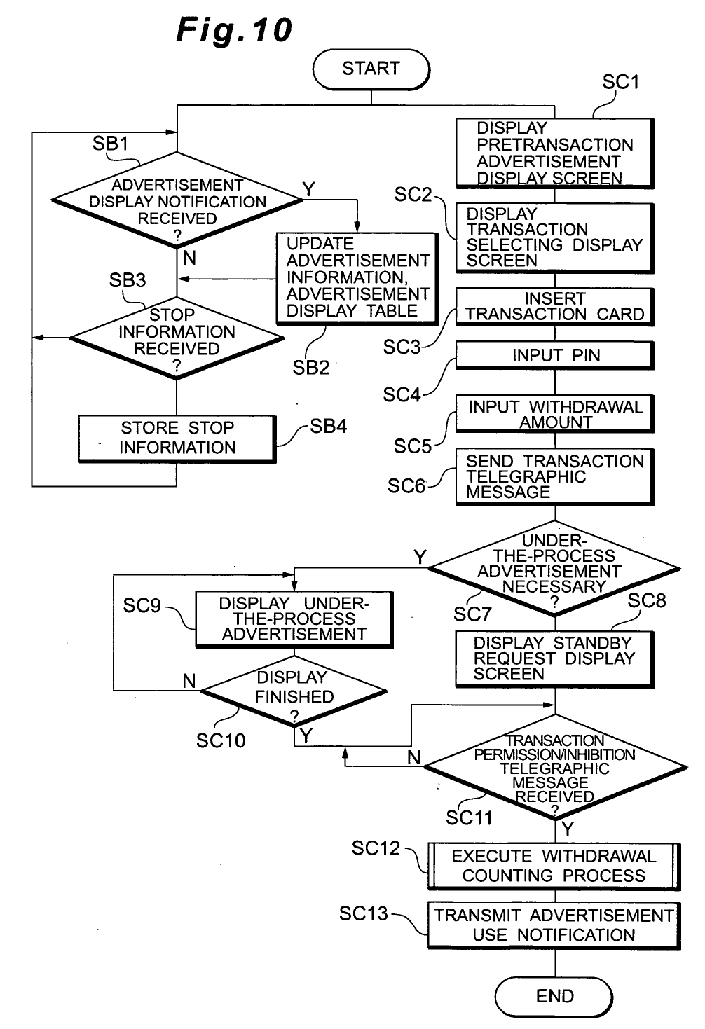

The operation of the advertisement displaying process of the automatic cash transaction apparatus 1 will be described hereinbelow in accordance with processing steps starting with “SB” and “SC” with reference to a flowchart shown in FIG. 10 with respect to a withdrawal transaction process in the automatic cash transaction apparatus 1 as an example.

A “business executing program” obtained by adding a routine for displaying an advertisement on the basis of an advertisement display notification distributed from the advertisement control apparatus 8 and a routine for transmitting a fact of the display of the under-the-process advertisement as an advertisement use notification to the management server 2 in the head office to an ordinary transaction processing program for previously executing various transactions with the customers has been stored in the ATM storing unit 22 of the automatic cash transaction apparatus 1 in the embodiment.

An advertisement display notification storing area for storing the advertisement display notification which is transmitted from the advertisement control apparatus 8 and to which the advertisement information, its advertisement display table, and the like have been attached is held in the ATM storing unit 22.

The person in charge in the service office turns on the power source of the automatic cash transaction apparatus 1 at the opening time or the like, thereby supplying an electric power to each section of the automatic cash transaction apparatus 1. Thus, the “business executing program” stored in the ATM storing unit 22 of the automatic cash transaction apparatus 1 is automatically activated. When the “business executing program” is activated, the ATM control unit 21 of the automatic cash transaction apparatus 1 starts the advertisement displaying process and executes in parallel an advertisement display notification storing process according to processing steps starting with “SB” and a transaction process (in the embodiment, withdrawal transaction process) accompanied with the advertisement display according to processing steps starting with “SC”.

SB1 . . . When the “business executing program” is activated, the ATM control unit 21 of the automatic cash transaction apparatus 1 is in a standby mode to wait for reception of the advertisement display notification from the advertisement control apparatus 8. When the advertisement display notification is received, step SB2 follows.

In this case, the advertisement display table shown in FIG. 6 and its advertisement information mentioned above have been attached to the advertisement display notification transmitted from the advertisement control apparatus 8.

When the advertisement display notification is not received, step SB3 follows.

SB2 . . . The ATM control unit 21 which received the advertisement display notification stores the received advertisement display table and its advertisement information into the advertisement display notification storing area of the ATM storing unit 22 and updates them, and step SB3 follows.

SB3 . . . The ATM control unit 21 is in a standby mode to wait for reception of the stop information from the advertisement control apparatus 8. When the stop information is received, step SB4 follows. When the stop information is not received, the processing routine is returned to step SB1 and the ATM control unit 21 continues the above standby mode.

SB4 . . . The ATM control unit 21 which received the stop information adds the stop information into the advertisement display notification storing area of the ATM storing unit 22 and stores (the operation in the case where the stop information has been stored will be described hereinafter).

The operation of the advertisement display notification storing process mentioned above is finished in response to the turn-off of the power source of the automatic cash transaction apparatus 1.

It is also possible to construct the system in such a manner that when the power source is turned off, the information stored in the advertisement display notification storing area is held by the backup power source or the like, and when the power source is turned on again, the advertisement displaying process of the automatic cash transaction apparatus 1 is executed on the basis of the stored information.

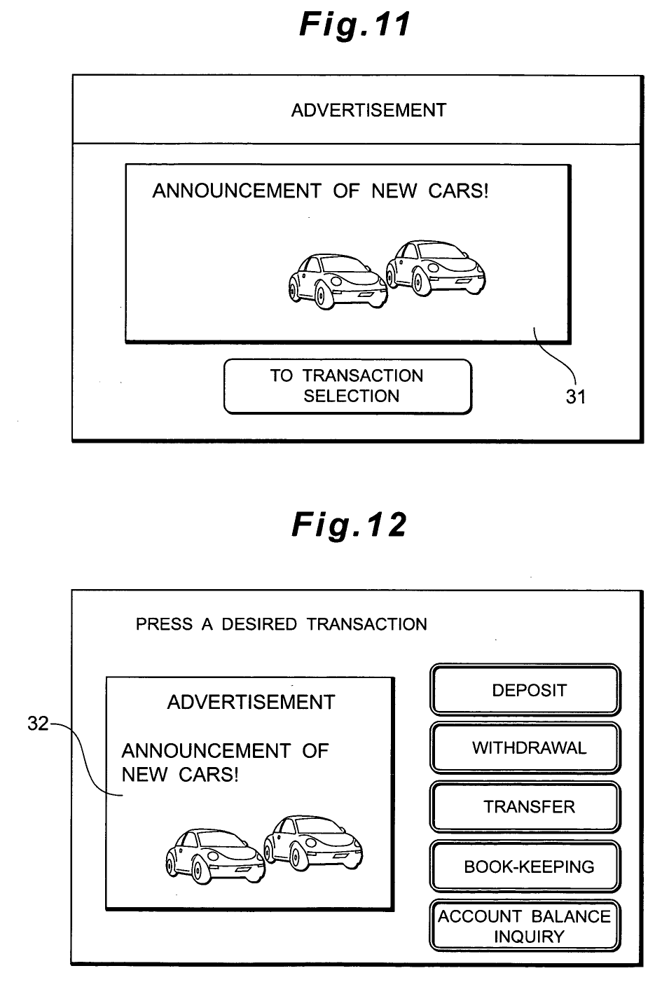

SC1 . . . When the “business executing program” is activated, the ATM control unit 21 displays a pretransaction advertisement display screen provided with a pretransaction advertisement display column 31 shown in FIG. 11 onto the customer operation unit 23.

That is, the ATM control unit 21 recognizes the present time/date by its timer function and extracts the display timing and the display information (the number of displaying times and the file names and the display times of the advertisement information which have been written in displaying order) in the corresponding advertisement time zone with reference to the advertisement display table in the advertisement display notification storing area of the ATM storing unit 22. The ATM control unit 21 displays the advertisement information of the first file name written at the display timing “before transaction selection” into the pretransaction advertisement display column 31 and displays the pretransaction advertisement display screen showing a “to transaction selection” button which is used by the customer for calling a transaction selecting display screen onto the customer operation unit 23.

While the advertisement information of the file name written in the display information, that is, the advertisement information in the pretransaction advertisement display column 31 is displayed in order in accordance with the display time in a manner similar to the monitor advertisement displaying process of the advertisement control apparatus 8, the ATM control unit 21 is in standby mode to wait for the depression of the “to transaction selection” button by the customer. When the customer depresses the “to transaction selection” button, step SC2 follows.

SC2 . . . The ATM control unit 21 which detected the depression of the “to transaction selection” button by the customer displays the transaction selecting display screen as a transaction display screen provided with a continuous advertisement display column 32 shown in FIG. 12 onto the customer operation unit 23.

In addition to messages for urging the customer to depress the transaction select buttons and ordinary transaction select buttons such as “withdrawal” button for a withdrawal transaction, “deposit” button for a paying transaction, and the like, the advertisement information of the file name written in the display information of the display timing “continuous” in the advertisement time zone corresponding to the present time/date is displayed as a continuous advertisement in the continuous advertisement display column 32 with reference to the advertisement display table in the advertisement display notification storing area of the ATM storing unit 22.

The customer selects the withdrawal transaction and depresses a “withdrawal” button by a touch panel.

The continuous advertisement which is displayed on the transaction display screen, which will be explained hereinbelow, is displayed in the continuous advertisement display column 32 provided for the transaction display screen in a manner similar to that mentioned above.

SC3 . . . The ATM control unit 21 which recognized the transaction selection by the customer by a position signal or the like from the touch panel displays a card insertion request display screen as a transaction display screen showing a message for urging the customer to insert a transaction card into the customer operation unit 23 and the continuous advertisement, thereby urging the customer to insert the transaction card. The customer inserts his transaction card into the card handling unit 24 in accordance with the message.

The ATM control unit 21 which detected the insertion of the transaction card reads out card information such as account information and the like recorded in the transaction card by the card handling unit 24.

SC4 . . . The ATM control unit 21 which read out the card information displays, onto the customer operation unit 23, a personal identification number (hereinbelow, abbreviated to a PIN) input display screen as a transaction display screen showing a message for urging the customer to input the PIN, a personal identification number input column, ten-key for inputting the PIN, and the continuous advertisement displayed in the continuous advertisement display column 32, thereby urging the customer to input his PIN. The customer inputs the PIN by the displayed ten-key or the like.

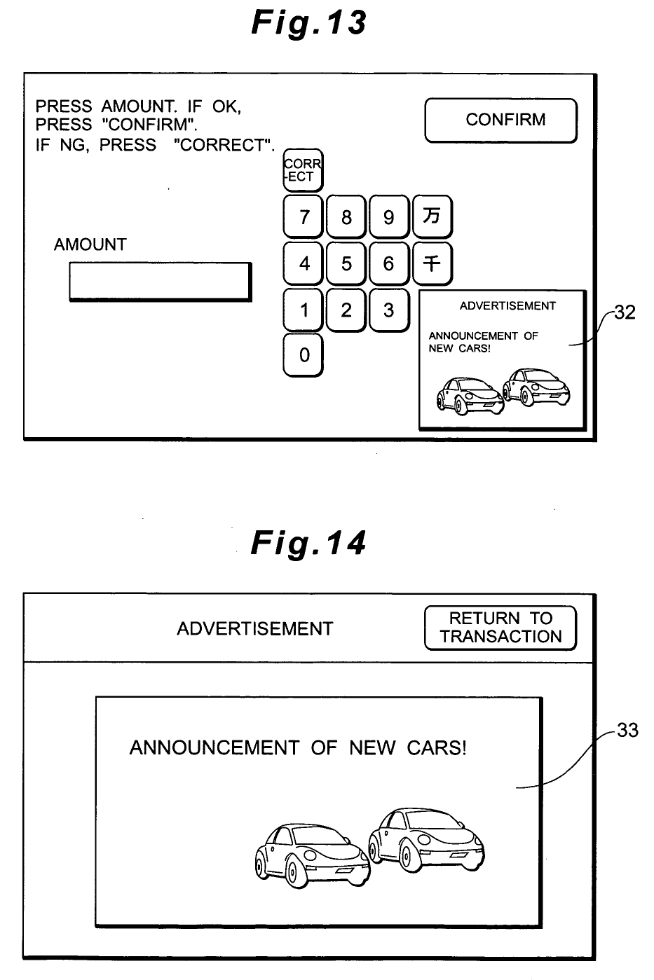

SC5 . . . The ATM control unit 21 which recognized the input of the PIN displays, onto the customer operation unit 23, an amount inputting display screen shown in FIG. 13 as a transaction display screen showing a message for urging the customer to input a withdrawal amount, a withdrawal amount input column, ten-key for inputting the withdrawal amount and the like, a “confirm” button to specify an input amount, and the continuous advertisement displayed in the continuous advertisement display column 32, thereby urging the customer to input the withdrawal amount. The customer inputs the withdrawal amount by the ten-key or the like displayed and depresses the “confirm” button.

SC6 . . . The ATM control unit 21 which detected the depression of the “confirm” button communicates with the host computer (not shown), forms a transaction telegraphic message attached with the PIN, the withdrawal amount, and the like inputted in the card information in order to executes a customer authenticating process, and transmits it to the host computer (not shown) through the communication line 3.

SC7 . . . The ATM control unit 21 which finished the transmission of the transaction telegraphic message refers to the advertisement display notification storing area of the ATM storing unit 22. If the stop information to stop the display of the under-the-process advertisement has been stored there, it is determined that the under-the-process advertisement is unnecessary, and step SC8 follows. If the stop information is not stored, it is determined that the under-the-process advertisement is necessary, and step SC9 follows.

SC8 . . . The ATM control unit 21 which determined that the under-the-process advertisement is unnecessary displays an ordinary standby request display screen showing a message for requesting the customer to wait for a little while onto the customer operation unit 23. The ATM control unit 21 enters a standby mode to wait for reception of a transaction permission/inhibition telegraphic message from the host computer (not shown) in step SC11, which will be explained hereinafter. The customer waits for a little while in accordance with the display contents.

SC9 . . . The ATM control unit 21 which determined that it is necessary to display the under-the-process advertisement displays, onto the customer operation unit 23, an under-the-process advertisement display screen, as an under-the-process advertisement, provided with an under-the-process advertisement display column 33 shown in FIG. 14.

The ATM control unit 21 refers to the advertisement display table in the advertisement display notification storing area of the ATM storing unit 22 and displays an under-the-process advertisement display screen onto the customer operation unit 23, wherein the advertisement information of the file name written in the display information of the display timing “under-the-process” in the advertisement time zone corresponding to the present time/date is displayed in the under-the-process advertisement display column 33 and a “return to transaction” button for returning to the transaction during the advertisement display is displayed on the under-the-process advertisement display screen.

The customer depresses the “return to transaction” button in the case of interrupting the advertisement display and returning to the transaction.

SC10 . . . When the display time of the display information of the display timing “under-the-process” elapses or when the depression of the “return to transaction” button by the customer is detected, the ATM control unit 21 finishes the display of the under-the-process advertisement, and step SC11 follows. In the other cases, the processing routine is returned to step SC9 and the display of the under-the-process advertisement is continued.

The host computer (not shown) which received the transaction telegraphic message sent in step SC6 searches for a ledger file on the basis of the account information of the transaction telegraphic message in order to authenticate the customer, collates the PIN of the corresponding customer with the PIN of the transaction telegraphic message. When the PIN coincides, the customer is authenticated. If the account balance is sufficient, the account balance of the corresponding customer is updated and a transaction permission/inhibition telegraphic message in which a message indicative of the permission of the transaction is written as a telegraphic message is formed. If the PIN does not coincide or the account balance is insufficient, a transaction permission/inhibition telegraphic message to which a message showing those contents has been attached and which indicates that the transaction is not permitted is formed. The formed transaction permission/inhibition telegraphic message is transmitted to the automatic cash transaction apparatus 1 through the communication line 3 and the intra-office LAN 4.

SC11 . . . The ATM control unit 21 is in a standby mode to wait for reception of the transaction permission/inhibition telegraphic message. If the under-the-process advertisement is unnecessary, when the transaction permission/inhibition telegraphic message is received, in the case where the under-the-process advertisement is displayed, this display is finished. When the transaction permission/inhibition telegraphic message is received, step SC12 follows. In the other cases, the ATM control unit 21 continues to standby in a waiting mode of the reception of the transaction permission/inhibition telegraphic message.

SC12 . . . The ATM control unit 21 which received the transaction permission/inhibition telegraphic message executes a withdrawal counting process on the basis of the received transaction permission/inhibition telegraphic message.

Since the operation of the withdrawal counting process is similar to the ordinary operation, its description is omitted here. In this case, when a transaction display screen such as a reception request display screen of the transaction card or the like is displayed, the continuous advertisement is displayed in the continuous advertisement display column 32 provided for such a transaction display screen in a manner similar to step SC2 mentioned above.

SC13 . . . The ATM control unit 21 which recognized the reception of the transaction card or the like by the customer transmits an advertisement use notification attached with the file name of the advertisement information displayed as an under-the-process advertisement and the number of displaying times (once in the embodiment) to the management server 2 through the intra-office LAN 4 and the communication line 3.

After that, the ATM control unit 21 finishes the withdrawal transaction process and returns to step SC1. The ATM control unit 21 allows the pretransaction advertisement display screen to be displayed onto the customer operation unit 23 and enters the standby mode.

The management server 2 which received the advertisement use notification from the automatic cash transaction apparatus 1 in step SC13 mentioned above specifies the advertiser who requested the advertisement display with reference to an advertiser reference table on the basis of the file name of the advertisement use notification, adds the received number of displaying times to a recording column of the accumulated number of displaying times of the corresponding file name in the accumulation table of the number of displaying times (display number accumulation table) shown in FIG. 4 in the use information storing area of the advertiser, and accumulates the number of displaying times.

The management server 2 totalizes the accumulation number of displaying times per advertiser periodically or as necessary, transmits the total value to the advertiser in an online manner, and charges an advertisement fee, or the management server 2 outputs the total value as a printed matter and the clerk in the head office charges the advertiser the advertisement fee.

The operation of the display stopping process of the automatic cash transaction apparatus 1 in the case where the stop information has been stored in step SB4 mentioned above will now be described hereinbelow.

The person in charge in the service office inputs the apparatus in which the advertisement display is stopped and the designation of contents to be stopped being displayed by combining them with an input code from the display stop designating display screen shown in FIG. 8 in step S8 of the advertisement control apparatus 8.

For example, when “5 (automatic cash transaction apparatus)” is inputted as an apparatus designation input code and “1(stop of schedule display)” is inputted as a contents designation input code, an input display screen of an apparatus number of the automatic cash transaction apparatus 1 is displayed as a next display screen in which “5” is designated as an apparatus designation input code. The apparatus numbers of a part or all of the automatic cash transaction apparatuses 1 are inputted and the automatic cash transaction apparatus 1 in which the contents designation input code “1” is executed is designated.

The advertisement control apparatus 8 which recognized such a designation input transmits the stop information describing a message of the stop of the schedule display to the automatic cash transaction apparatus 1 designated by the apparatus number.

If the stop information mentioned above has been stored when the ATM control unit 21 of the automatic cash transaction apparatus 1 which received the stop information refers to the advertisement display notification storing area of the ATM storing unit 22 in step SC1, the ATM control unit 21 stops the display of the pretransaction advertisement and displays an ordinary initial display screen.

When the advertisement display notification storing area is referred to in the case of displaying the transaction display screen in step SC2 or the like, if the stop information has been stored, an ordinary transaction display screen in which the continuous advertisement display column 32 is omitted is displayed.

Since the stop information is stop information to stop the display of the under-the-process advertisement in step SC7, the processing routine advances to step SC8 as described in step SC7 and an ordinary standby request display screen is displayed.

As mentioned above, when the above designation is inputted, the automatic cash transaction apparatus 1 executes only the ordinary transaction process.

When “4 (restart of schedule display)” is designated as a contents designation input code from the above display stop designating display screen, the ATM control unit 21 which received the stop information deletes the stop information held in step SB4. Thus, the advertisement displaying process mentioned above is restarted.

If “2” or “4” is inputted as an apparatus designation input code of the display stop designating display screen when a plurality of lobby display apparatuses 10 and the monitor 9 are set, an input display screen to designate the apparatus number is displayed as a next display screen and the apparatus number is designated in a manner similar to that mentioned above.

In this case, when “1 (whole business office)” or “3 (ATM corner set apparatus)” is inputted as an apparatus designation input code, the contents designation of the contents designation input code designated in all of the apparatuses set at this place is applied.

Further, “2 (display stop of specific advertisement information)” or “3 (display of specific advertisement information)” is inputted as a contents designation input code of the display stop designating display screen, an input display screen to input the display timing and the display information is displayed as a next display screen, thereby allowing the file name, display timing, and the like of the specific advertisement information whose display is stopped or which is displayed to be designated. Thus, the stop information showing such a fact is transmitted to the corresponding apparatus. The contents designation is applied in a displaying step of the designated advertisement display. If the lobby display apparatus 10 and the monitor 9 have been designated as an apparatus designation, even if the display timing is inputted, their contents are ignored.

The advertisement displaying process and the like of the automatic cash transaction apparatus 1 based on the stop information from the advertisement control apparatus 8 are executed as mentioned above.

It is also possible to enable the display stop designating display screen to be displayed also to the clerk terminal 5 in the head office and enable the apparatus designation and the like to be inputted from the clerk terminal 5. In this case, input codes for designating the region and the service office are added to the display stop designating display screen. Thus, the advertisement display is concentratedly managed and efficiency of the advertisement display can be improved.

As described above, according to the embodiment, the advertisement control apparatus receives the advertisement display table and the advertisement information from the advertisement operation server, distributes them to the automatic cash transaction apparatuses, displays the advertisement information thereto, and displays the advertisement information onto the monitor on the basis of the advertisement display tables. Therefore, the similar advertisement can be displayed to the monitor and the automatic cash transaction apparatuses. The advertisement information can be displayed not only to the customer who transacts business by the automatic cash transaction apparatus but also to the transaction-waiting customers. It is possible to advertise generally to the customers who visit the financial institution or the like.

Since the similar advertisement information is displayed to the monitor and the automatic cash transaction apparatuses, multiple effect of the advertisement can be obtained.

Further, since the similar advertisement information is displayed to the automatic cash transaction apparatuses of the display timing of each of the three cases “before transaction selection”, “under-the-process”, and “continuous”, the advertisement information can be even more generally advertised to the customers.

Moreover, in the case of displaying a plurality of advertisement information, the pretransaction advertisements of the monitor, the lobby display apparatus, and the automatic cash transaction apparatus are sequentially displayed on the basis of the advertisement time zone and the display information in the advertisement display table. Therefore, all of the requested advertisement information can be displayed and the advertisement display can be performed in accordance with the will of the advertiser.

As mentioned above, it is possible to realize the advertisement display system which can advertise generally to the customers who visit the financial institution or the like in accordance with the will of the advertiser. Such an effect can be further enhanced if the display screens of the monitor and the lobby display apparatus are enlarged in size,.

Although the embodiment has been described on the assumption that the advertisement information is supplied from the advertisers, the advertisement information to be displayed is not limited to the advertisement information of the advertisers but can be advertisement information such as advertisement for financial products or the like, public information, or the like formed by the financial institution or the like. In this case, it is preferable that the advertisement information of the financial institution or the like is formed by the clerk terminal in the head office, transmitted to the advertisement operation server through the communication line, and stored into the advertisement information database, the file name is written into the advertisement display table, and the advertisement information of the financial institution or the like is displayed.

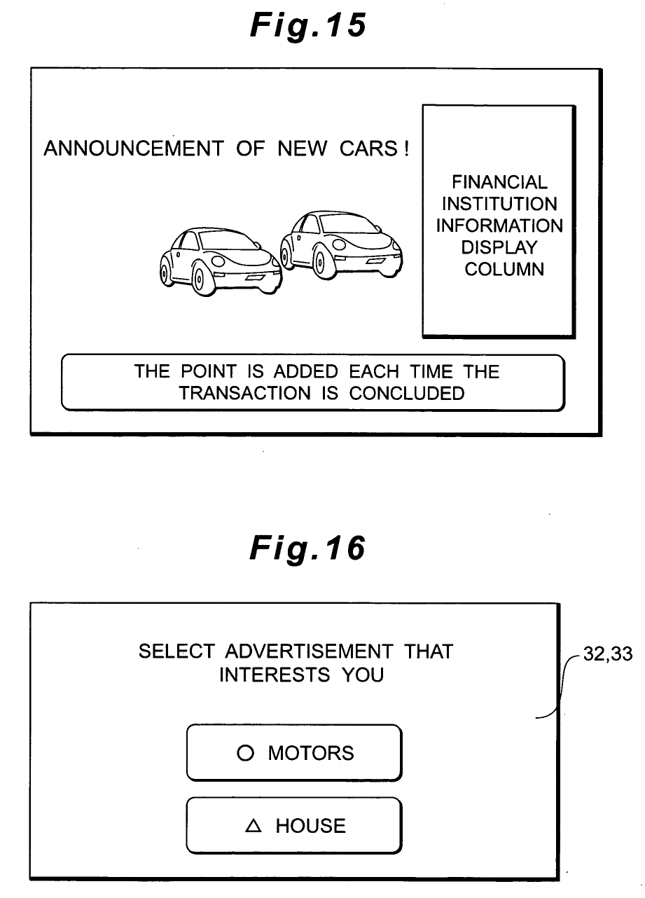

As a monitor advertisement display screen shown in FIG. 15 and provided with a news display column, characters news or the like about a finance, economy, politics, current affairs, sports, and the like can be also displayed on the monitor advertisement display screen shown in FIG. 9 which is displayed on the monitor screens of the monitor and the lobby display apparatuses. In this case, it is preferable that the news information of the characters news is stored into the advertisement information database of the advertisement operation server, when the advertisement display table is transmitted to the advertisement control apparatus, the news information is transmitted together with it and added to the monitor advertisement display screen shown in FIG. 9, and they are displayed on the monitor screens of the monitor and the lobby display apparatuses.

Further, as a continuous advertisement which is displayed on the transaction display screen, it is also possible that the transaction display screen for displaying the continuous advertisement is preset and the continuous advertisement is displayed only on one or a plurality of specific transaction display screens. In this case, the ordinary transaction display screen is displayed on the transaction display screen which does not display the continuous advertisement.

Moreover, it is also possible that the customer selects the advertisement information which is displayed in the continuous advertisement or the under-the-process advertisement. In this case, the following form is used.

FIG. 16 shows a display example of a continuous advertisement display column and an under-the-process advertisement display column in another form in the embodiment 1.

As shown in FIG. 16, a display screen provided with advertisement select buttons is displayed in the continuous advertisement display column 32 of the transaction display screen in step SC2 or the like mentioned above and on the under-the-process advertisement display column 33 of the under-the-process advertisement display screen in step SC9 in the embodiment.

Button names set by the advertisers such as names of the advertisers, names of the trademarks, keywords showing the products or the like to be advertised, and the like are displayed on the advertisement select buttons. In the embodiment, the names of the advertisers are set into the button names.

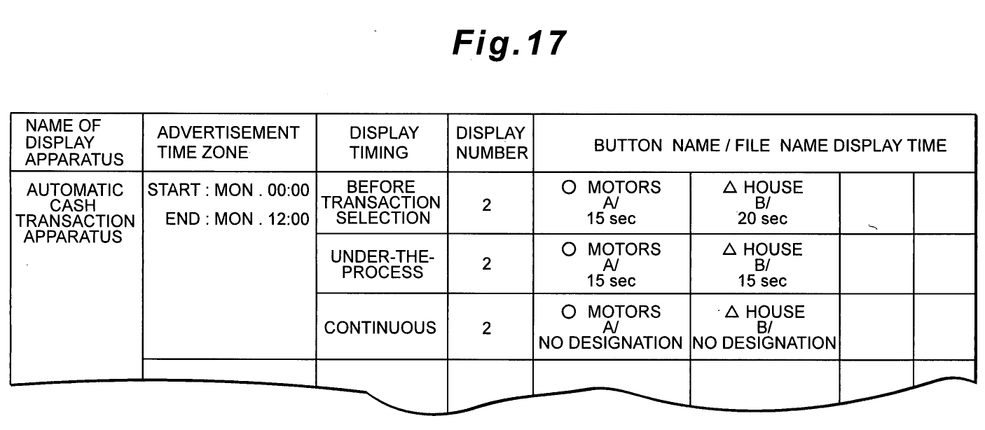

To display the button names which are displayed on the advertisement select buttons, an advertisement display table shown in FIG. 17 is used as an advertisement display table of the automatic cash transaction apparatus 1 in the embodiment. The button names are added to the display information of the advertisement display table.

According to the advertisement display information storing process of the advertisement control apparatus 8 in the embodiment, the apparatus control unit 11 receives the advertisement information or the like comprising the advertisement display tables of FIGS. 5 and 17 and their advertisement information in step S4 mentioned above and distributes the advertisement display notification attached with the advertisement display table shown in FIG. 17 and its advertisement information to the automatic cash transaction apparatus 1 in step S6.

According to the advertisement displaying process of the automatic cash transaction apparatus 1 in the embodiment, the ATM control unit 21 receives the advertisement display table in FIG. 17 and the like as an advertisement display notification in step SB1 mentioned above, stores into the advertisement display notification storing area, and updates in step SB2.

According to the transaction process accompanied with the advertisement display of the automatic cash transaction apparatus 1 in the embodiment, the ATM control unit 21 displays the display screen provided with the advertisement select buttons shown in FIG. 16 as a continuous advertisement onto the continuous advertisement display column 32 from the number of displaying times and the button names written in the display information of the display timing “continuous” in the advertisement time zone corresponding to the present time/date in step SC2. Other processes are also executed in a manner similar to those in the transaction display screen in step SC3 and the subsequent steps.

Further, in step SC9, the ATM control unit 21 displays the display screen provided with the advertisement select buttons shown in FIG. 16 onto the under-the-process advertisement display column 33 from the number of displaying times and the button names written in the display information of the display timing “under-the-process” in the advertisement time zone corresponding to the present time/date. The ATM control unit 21 also displays an under-the-process advertisement display screen on which the “return to transaction” button to return to the transaction during the advertisement display has been displayed onto the customer operation unit 23.

When the display screen provided with the advertisement select buttons in the embodiment is displayed as mentioned above, if the customer depresses either of the advertisement select buttons on the display screen, the ATM control unit 21 refers to the display information, recognizes the file name of the advertisement information selected by the customer, temporarily stores the file name into the ATM storing unit 22, and sets the system into a mode in which the subsequent depression of the advertisement select button (hereinbelow, this mode is referred to as a locking mode).

In the case where the display screen provided with the advertisement select buttons is displayed as a continuous advertisement onto the transaction display screen, if the timing when the customer depresses the advertisement select button is timing before the sending of the transaction telegraphic message in step SC6, a display screen on which the advertisement information of the file name which has temporarily been stored is displayed (hereinbelow, such a display screen is referred to as a selected advertisement display screen) as an under-the-process advertisement display screen in step SC9 is displayed in the under-the-process advertisement display column 33 of the under-the-process advertisement display screen shown in FIG. 14.

In the case of the transaction display screen in which the timing when the customer depresses the advertisement select button is during the execution of a withdrawal counting process in step SC12, the selected advertisement display screen is displayed after completion of the process in step SC12. In this case, the display of the advertisement information is finished when the display time of the advertisement information elapses.

In the case where the display screen provided with the advertisement select buttons in the embodiment is displayed on the under-the-process advertisement display screen in step SC9 mentioned above, when the customer depresses the advertisement select button, the selected advertisement display screen is displayed as a next display screen or as an advertisement display screen after the end of the transaction. If no advertisement select button is depressed, when the transaction permission/inhibition telegraphic message is received in step SC11, the display of the display screen provided with the advertisement select buttons is finished and step SC12 follows.

It is also possible to construct the system in such a manner that when the customer depresses the advertisement select button before the transaction telegraphic message is transmitted, the display screen provided with the advertisement select buttons in the locking mode is displayed as an under-the-process advertisement display screen in step SC9 onto the under-the-process advertisement display column 33, and the selected advertisement display screen is displayed after the end of the process in step SC12.

In the case where the selected advertisement display screen is displayed as mentioned above, the file name which has temporarily been stored is transmitted as a file name which is transmitted as an advertisement use notification to the management server 2 in step SC13. After it was transmitted, the ATM control unit 21 deletes the file name which has temporarily been stored.

If no advertisement select button is depressed until the end of the transaction process, the transmission of the advertisement use notification in step SC13 is omitted.

According to the above embodiment, in addition to the effects of the embodiment 1, the customer can select and display the advertisement, use convenience of the customer can be improved, and the advertiser can grasp reputation or the like of his own products or the like.

### Embodiment 2

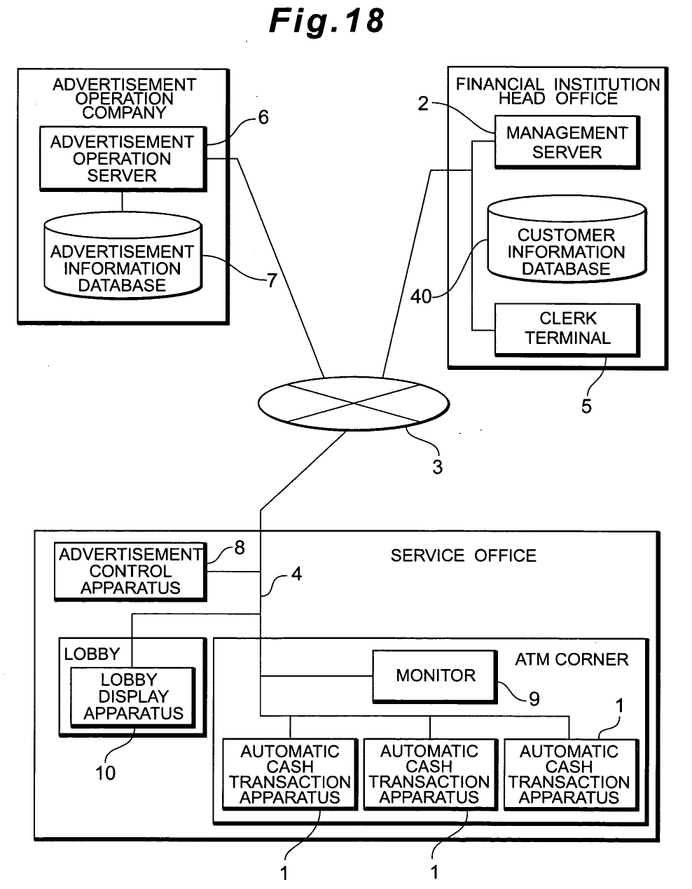

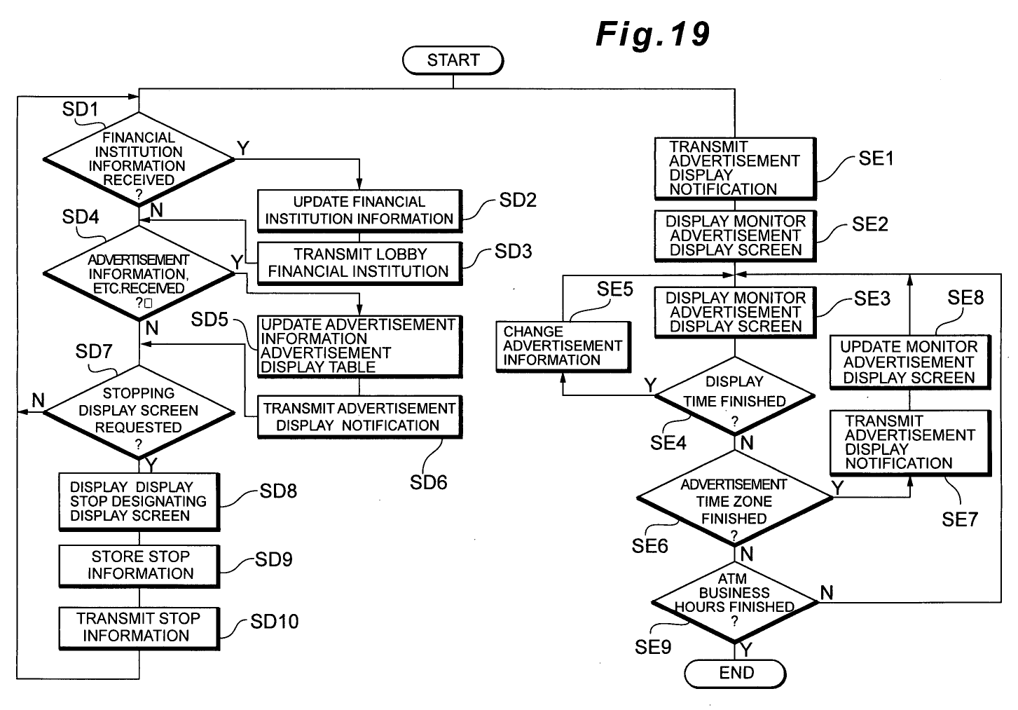

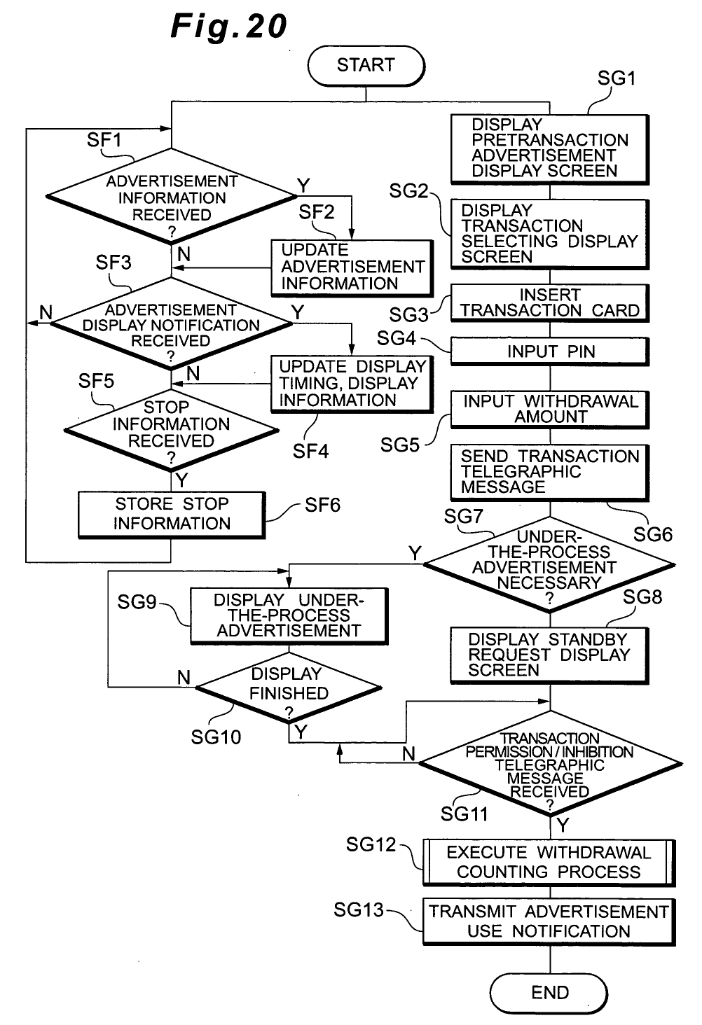

FIG. 18 is a block diagram showing a construction of a system in an embodiment 2. FIG. 19 is a flowchart showing an advertisement control process of an advertisement control apparatus in the embodiment 2. FIG. 20 is a flowchart showing an advertisement displaying process of an automatic cash transaction apparatus in the embodiment 2.

The construction of the advertisement control apparatus 8 and the automatic cash transaction apparatus 1 in the embodiment 2 is similar to that shown in FIGS. 2 and 3 of the embodiment 1. Component elements similar to those in the embodiment 1 are designated by the same reference numerals and their description is omitted here.

In FIG. 18, reference numeral 40 denotes a customer information database which the management server 2 set in the head office of the financial institution or the like has. Customer information such as address, name, birthday, occupation, family structure, telephone number, E-mail address, and the like of the customer has been stored in the customer information database in correspondence to the customer ID (identification) such as an account number or the like of the customer.

The operation of the above construction will now be described.

Since trust and a contract among the financial institution or the like, the advertisement operation company, and the advertiser are similar to those in the embodiment 1, their description is omitted here.

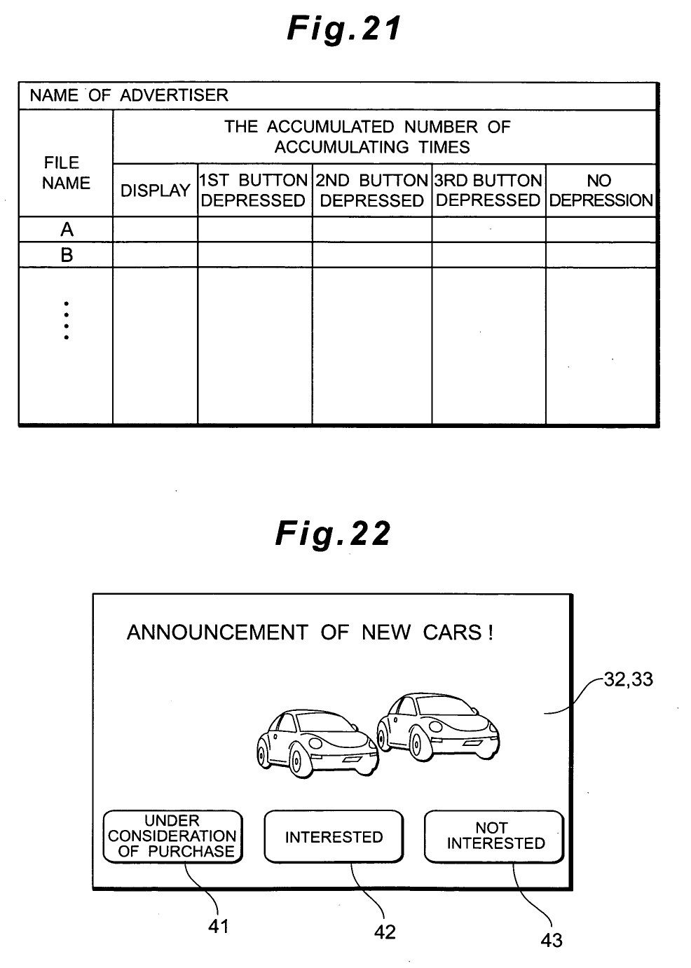

An advertiser reference table similar to that in the embodiment 1 is stored into a storing unit (not shown) of the management server 2 in the embodiment and a use information storing area is held therein. An accumulation table of the number of displaying times per advertiser shown in FIG. 21 to which, in addition to the recording column in the embodiment 1, a recording column of an accumulated number of depressing times of reaction collect buttons (a first button, a second button, and a third button in the embodiment) for collecting the reactions of the customer has been added has been stored in the use information storing area.

The advertisement operation server 6 in the embodiment transmits the advertisement display tables shown in FIGS. 5 and 6 and their advertisement information to the advertisement control apparatus 8 of the corresponding service office in a manner similar to that in the embodiment 1. The clerk terminal 5 transmits the financial institution information to the advertisement control apparatus 8 of the corresponding service office in a manner similar to that in the embodiment 1.

The advertisement control process of the advertisement control apparatus 8 will now be described hereinbelow with reference to the flowchart shown in FIG. 19 in accordance with processing steps starting with “SD” and “SE”.

An advertisement display information storing area has been held in the apparatus storing unit 12 of the advertisement control apparatus 8 in the embodiment in a manner similar to that in the embodiment 1.

When the person in charge in the service office turns on the power source of the advertisement control apparatus 8 in a manner similar to that in the embodiment 1, the apparatus control unit 11 starts the advertisement control process and executes in parallel an advertisement display information storing process in each step starting with “SD” and a monitor advertisement displaying process in each step starting with “SE”.

Since the operations in steps SD1 to SD5 are similar to those in steps S1 to S5 in the embodiment 1, their description is omitted here.

SD6 . . . The apparatus control unit 11 which finished the updating of the advertisement information and the like transmits the advertisement information such as updated advertisement information or the like to the lobby display apparatus 10 and distributes it to the automatic cash transaction apparatus 1, and step SD7 follows. The advertisement display tables shown in FIGS. 5 and 6 have been held in the advertisement display information storing area in the apparatus storing unit 12.

Since the subsequent operations in steps SD7 to SD10 are similar to those in steps S7 to S10 in the embodiment 1, their description is omitted here.

The operation of the advertisement display information storing process of the advertisement control apparatus 8 is executed in the above processing steps.

SE1 . . . When the power source is turned on, the apparatus control unit 11 of the advertisement control apparatus 8 recognizes the present time/date by its timer function, refers to the corresponding advertisement time zone in the advertisement display table shown in FIG. 6 in the advertisement display information storing area of the apparatus storing unit 12, and distributes the display timing and the display information as an advertisement display notification to the automatic cash transaction apparatus 1 through the intra office LAN 4. The apparatus control unit 11 also refers to the corresponding advertisement time zone of the display apparatus name “lobby display apparatus” in the advertisement display table shown in FIG. 5 in the advertisement display information storing area and transmits the display information to the lobby display apparatus 10 through the intra-office LAN 4.

The lobby display apparatus 10 which received the display information reads out the advertisement information of the first file name written in the display information from the advertisement information which has previously been received in step SD6 and displays it onto the display screen together with the lobby financial institution information or the like.

When the automatic cash transaction apparatus 1 and the lobby display apparatus 10 are not activated yet, the apparatus control unit 11 executes the operation in step SE1 after waiting for the activation of them.

Since the subsequent operations in steps SE2 to SE6 are similar to those in steps SA1 to SA5 in the embodiment 1, their description is omitted here.

SE7 . . . The apparatus control unit 11 which determined that the present advertisement time zone has been finished refers to each advertisement display table for the automatic cash transaction apparatus 1 and the lobby display apparatus 10 in a manner similar to step SE1 mentioned above and transmits the advertisement display notification and the display information in the advertisement time zone corresponding to the present time/date to them.

Since the subsequent operations in steps SE8 and SE9 are similar to those in steps SA6 and SA7 in the embodiment 1, their description is omitted here.

By the monitor advertisement displaying process of the advertisement control apparatus 8 mentioned above, the advertisement display of the whole service office of the financial institution or the like is concentratedly controlled and the same advertisement information is repetitively displayed in order in the same time zone in the state where the time-dependent deviation is eliminated.

The operation of the advertisement displaying process of the automatic cash transaction apparatus 1 will be described hereinbelow with reference to the flowchart shown in FIG. 20 with respect to the withdrawal transaction process in the automatic cash transaction apparatus 1 in accordance with processing steps starting with “SF” and “SG”.

A “business executing program” similar to that in the embodiment 1 is stored in the ATM storing unit 22 of the automatic cash transaction apparatus 1 in the embodiment and an advertisement display notification storing area has been held in the ATM storing unit 22.

Advertisement information accompanied with a first button 41, a second button 42, and a third button 43 as reaction collect buttons shown in FIG. 22 is displayed in the continuous advertisement display column 32 and the under-the-process advertisement display column 33 in the embodiment.

In the embodiment, “under consideration of purchase” is set as a first button 41, “interested” is set as a second button 42, and “not interested” is set as a third button 43.

The reaction collect buttons are constructed so that the advertiser can freely set them. For example, it is also possible to set “sending of materials” as a first button 41, “guidance by telephone” as a second button 42, and “guidance by E-mail” as a third button 43, or the like.

When the person in charge in the service office turns on the power source of the automatic cash transaction apparatus 1 and the “business executing program” is activated in a manner similar to that in the embodiment 1, the ATM control unit 21 starts the advertisement displaying process and executes in parallel an advertisement display notification storing process in steps starting with “SF” and a transaction process accompanied with the advertisement display (in the embodiment, withdrawal transaction process) in steps starting with “SG”.

SF1 . . . When the “business executing program” is activated, the ATM control unit 21 of the automatic cash transaction apparatus 1 is in a standby mode to wait for the reception of the advertisement information from the advertisement control apparatus 8. When the advertisement information is received, step SF2 follows. When the advertisement information is not received, step SF3 follows.

In this case, the advertisement information corresponding to all file names written in the advertisement display table shown in FIG. 6 is transmitted from the advertisement control apparatus 8.

SF2 . . . The ATM control unit 21 which received the advertisement information stores the received advertisement information into the advertisement information storing area of the ATM storing unit 22 and updates it, and step SF3 follows.

SF3 . . . The ATM control unit 21 is in a standby mode to wait for the reception of the advertisement display notification in a manner similar to step SB1 in the embodiment 1. When the advertisement display notification is received, step SF4 follows. When the advertisement display notification is not received, step SF5 follows.

SF4 . . . The ATM control unit 21 which received the advertisement display notification stores the received display timing and its display information into the advertisement display notification storing area of the ATM storing unit 22 and updates them, and step SF5 follows.

Since the subsequent operations in steps SF5 and SF6 are similar to those in steps SB3 and SB4 in the embodiment 1, their description is omitted here.

The operation of the advertisement display notification storing process of the automatic cash transaction apparatus 1 in the embodiment is executed as mentioned above.

SG1 . . . When the “business executing program” is activated, the ATM control unit 21 is in a standby mode to wait for depression of the “to transaction selection” button by the customer while displaying the pretransaction advertisement display screen shown in FIG. 11 onto the customer operation unit 23 in a manner similar to step SC1 in the embodiment 1. When the customer depresses the “to transaction selection” button, step SG2 follows.

As advertisement information which is displayed in this case, advertisement information of the first file name written in the display information of the display timing “before transaction selection” stored in the advertisement display notification storing area in step SF4 is used.

SG2 . . . The ATM control unit 21 which detected the depression of the “to transaction selection” button of the customer displays a transaction selecting display screen as a transaction display screen shown in FIG. 12 onto the customer operation unit 23 in a manner similar to step SC1 in the embodiment 1. The customer selects the withdrawal transaction and depresses a “withdrawal” button.

As advertisement information which is displayed in the continuous advertisement display column 32 in this case, advertisement information of the file name written in the display information of the display timing “continuous” stored in the advertisement display notification storing area in step SF4 mentioned above, that is, advertisement information accompanied with the reaction collect buttons shown in FIG. 22 is used. (The operation which is executed when the reaction collect button is depressed will be described hereinafter.)

In the continuous advertisement which is displayed in the continuous advertisement display column 32 on a transaction display screen, which will be explained hereinbelow, the advertisement information shown in FIG. 22 is displayed in a manner similar to that mentioned above.

Since the subsequent operations in steps SG3 to SG12 are similar to those in steps SC3 to SC12 in the embodiment 1, their description is omitted here.

As display information which is displayed in the under-the-process advertisement display column 33 in step SG9, advertisement information of the file name written in the display information of the display timing “under-the-process” stored in the advertisement display notification storing area in step SF4 mentioned above, that is, the display screen of the advertisement information shown in FIG. 22 is used.

When the customer depresses one of the reaction collect buttons, the ATM control unit 21 temporarily stores types of the depressed first button 41, the second button 42, and the third button 43 into the ATM storing unit 22 and sets the reaction collect button into the locking mode in a manner similar to that in the embodiment 1. The above description is also true of the case where the reaction collect button in the continuous advertisement display column 32 displaying the advertisement information shown in FIG. 22 has been depressed.

SG13 . . . The ATM control unit 21 which confirmed the reception of the transaction card or the like by the customer transmits an advertisement use notification attached with the file name and its number of displaying times (1 in the embodiment) of the advertisement information displayed as an under-the-process advertisement, the type of reaction collect button depressed by the customer (for example, the first button; when no reaction collect button is depressed, “no depression”), and the card information of the transaction card read out in step SG3 mentioned above to the management server 2 through the intra-office LAN 4 and the communication line 3.

After that, the ATM control unit 21 finishes the withdrawal transaction process, returns to step SG1, displays the pretransaction advertisement display screen onto the customer operation unit 23, and enters a standby mode.

The operation of the advertisement displaying process of the automatic cash transaction apparatus 1 in the embodiment is executed as mentioned above.

Since the operation of the display stopping process of the automatic cash transaction apparatus 1 is similar to that in the embodiment 1, its description is omitted here.

The management server 2 which received the advertisement use notification from the automatic cash transaction apparatus 1 in step SG13 specifies the advertiser who requested the advertisement display with reference to the advertiser reference table on the basis of the file name of the advertisement use notification, adds the received number of displaying times to the recording column of the accumulated number of displaying times of the corresponding file name in the accumulation table of the number of displaying times shown in FIG. 21 in the use information storing area of the advertiser, and accumulates the number of displaying times. The management server 2 adds the number of depressing times (1 in the embodiment) to the accumulated number of depressing times in the recording column corresponding to the type of reaction collect button of the advertisement use notification (the first button is depressed in the embodiment) and accumulates the number of depressing times.

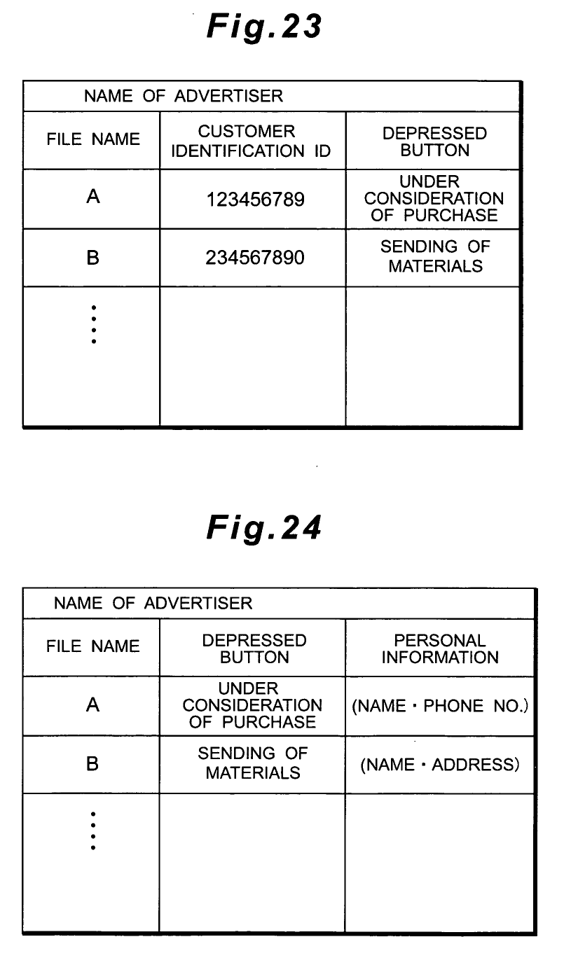

The management server 2 reads out the customer identification ID from the card information of the advertisement use notification and time-sequentially records the set contents of the depressed reaction collect button as contents of the file name of the advertisement information, the customer identification ID, and the depressed button into the customer reaction collection table per advertiser shown in FIG. 23.

The management server 2 totalizes the accumulated number of displaying times and the accumulated number of depressing times per advertiser periodically or as necessary, transmits them to the advertiser in an on-line manner together with the recorded customer reaction collection table, and charges the advertisement fee. The management server 2 outputs the obtained values as a printed matter and the clerk or the like in the head office charges the advertiser the advertisement fee.

Thus, the financial institution or the like can add a consideration for the sum of the customer reactions and charge. The advertiser and the advertisement operation company can extract the addresses and telephone numbers of the customers on the basis of the customer identification ID in the customer reaction collection table by using the customer information of the financial institution or the like, and guide products or the like to them.

If there is an obstacle when the advertiser or the like uses the customer information of the financial institution or the like, the management server 2 searches the customer information database 40 on the basis of the customer identification ID, extracts the customer information of the corresponding customer, forms another customer reaction collection table shown in FIG. 24 in which only the customer information which is necessary for allowing the advertiser or the like to correspond to the set contents of the depressed reaction collect button has been written (for example, when the depressed button is the “under consideration of purchase”, only the name and the telephone number of the customer are written) in the personal information column, and supplies it to the advertiser or the like.

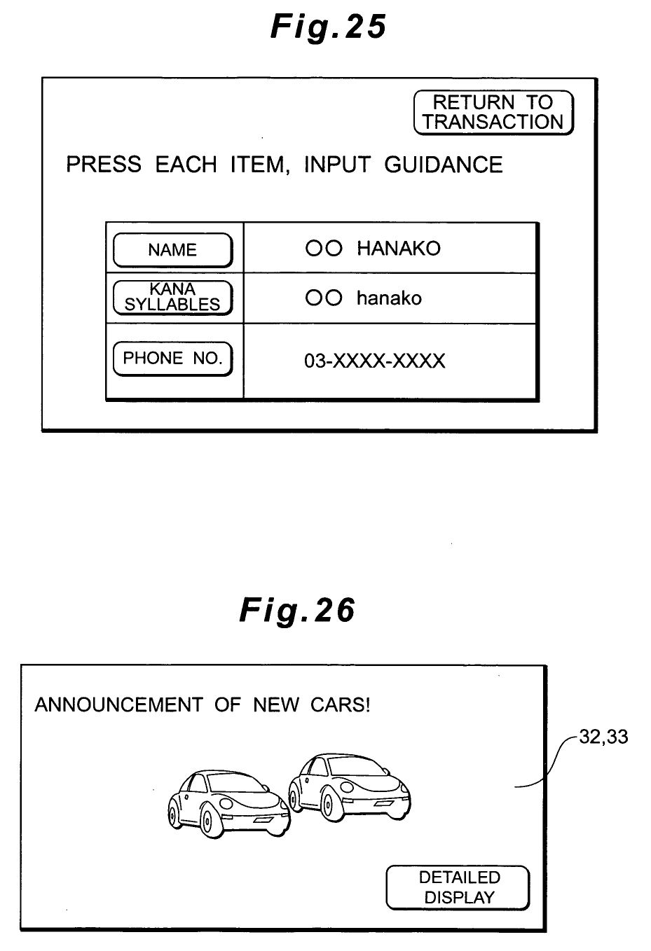

Or, when the reaction collect button is depressed, a personal information inputting display screen shown in FIG. 25 displaying a personal information inputting column for inputting a message to urge the operator to input his personal information, an operating method of the input, and items which are necessary for correspondence of the depressed reaction collect button in the personal information such as name of the customer, its kana syllables, address, telephone number, E-mail address, and the like is displayed as a next display screen or after the end of the transaction, thereby collecting the personal information of the customer.

In this case, the inputted personal information is attached to the advertisement use notification in step SG13 mentioned above and the management server 2 forms another customer reaction collection table in FIG. 24.

As described above, according to the embodiment, in addition to the foregoing effects of the embodiment 1, since the advertisement time zone in which the advertisement control apparatus displays the advertisement information is managed, even if an error exists in the timer functions built in the apparatuses of the service offices, the advertisement display timing of all of the apparatuses can be synchronized.

Since the reaction collect buttons are provided on the continuous advertisement display screen and the under-the-process advertisement display screen of the automatic cash transaction apparatus, the reactions of the customers are collected and totalized, and the total value is supplied to the advertiser, the financial institution or the like can additionally charge a consideration for the sum of the reactions of the customers.

Although the embodiment has been described on the assumption that the reaction collect buttons are provided on the display screen shown in FIG. 22 and the reactions of the customers are collected, it is also possible to construct the system in such a manner that advertisement information provided with a “detailed display” button for displaying further detailed information shown in another display example of FIG. 26 is displayed in the continuous advertisement display column 32 and the under-the-process advertisement display column 33, the number of displaying times of the detailed information is recorded in a manner similar to that mentioned above, and an additional advertisement fee is charged.

### Embodiment 3

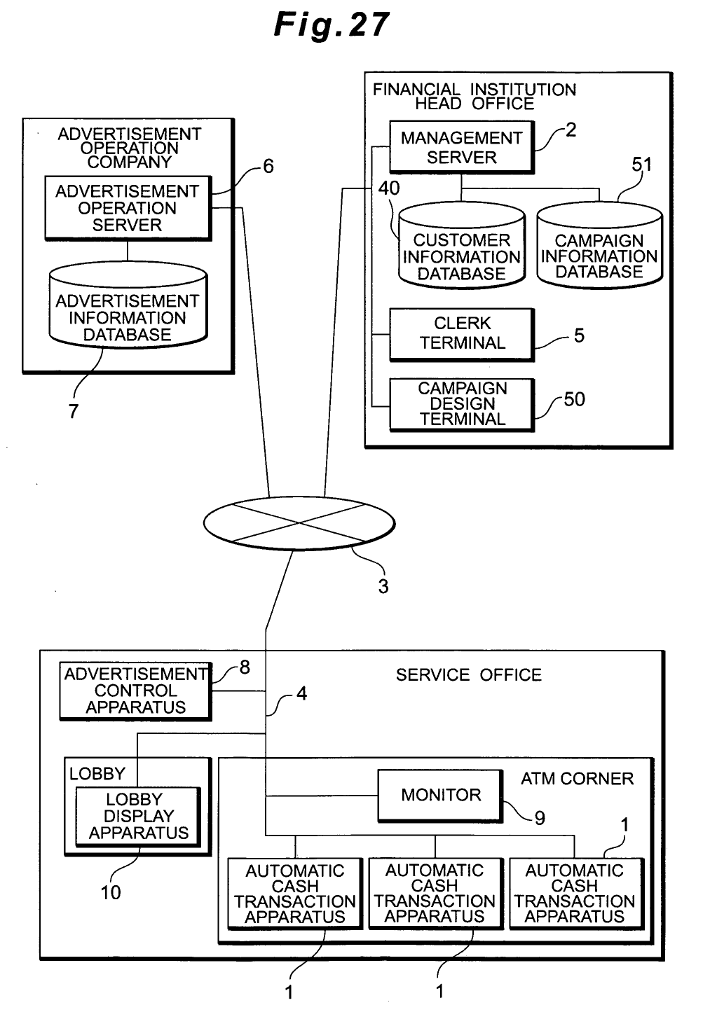

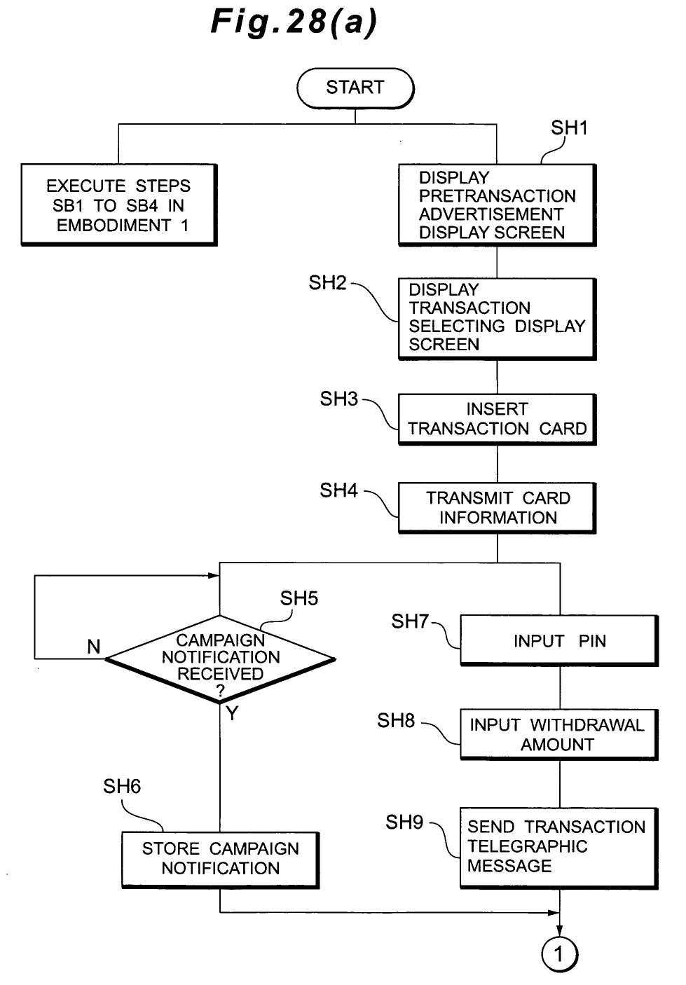

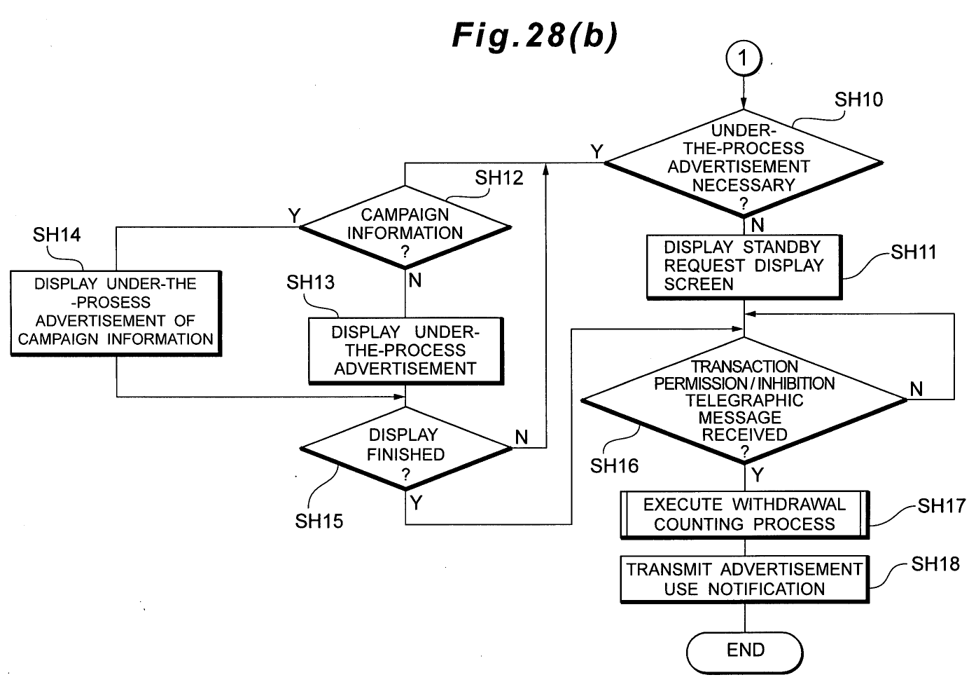

FIG. 27 is a block diagram showing a construction of a system in an embodiment 3. FIG. 28 is a flowchart showing an advertisement displaying process of an automatic cash transaction apparatus in the embodiment 3.

A construction of the advertisement control apparatus 8 and the automatic cash transaction apparatus 1 in the embodiment 3 is similar to that shown in FIGS. 2 and 3 in the embodiment 1. Component elements similar to those in the embodiments 1 and 2 are designated by the same reference numerals and their description is omitted here.

In FIG. 27, reference numeral 50 denotes a campaign design terminal set in the head office of the financial institution or the like. The campaign design terminal 50 is connected to the management server 2 through the LAN or the like. The campaign design terminal 50 is also connected to the communication line 3, the advertisement operation server 6, and the intra-office LAN 4 of the service office and can make data communication with the automatic cash transaction apparatus 1.

A campaign designer in the head office designs campaign information of financial products or the like of the financial institution or the like which is displayed in an under-the-process advertisement of the automatic cash transaction apparatus 1 by the campaign design terminal 50, associates it with the identification ID of the customer and the file name of the advertisement information of the advertiser, and transmits the designed campaign information to the management server 2. The management server 2 previously stores it into a campaign information database 51.

The operation of the above construction will now be described.

Since trust and a contract among the financial institution or the like, the advertisement operation company, and the advertiser are similar to those in the embodiment 1, their description is omitted here.

The accumulation table of the number of displaying times shown in FIG. 4 has been stored in the use information storing area of the storing unit (not shown) of the management server 2 in the embodiment in a manner similar to that in the embodiment 1.

The advertisement operation server 6 in the embodiment 3 transmits the advertisement display tables shown in FIGS. 5 and 6 and the advertisement information to the advertisement control apparatus 8 of the corresponding service office in a manner similar to that in the embodiment 1 and also transmits the advertisement display table of the automatic cash transaction apparatus 1 shown in FIG. 6 to the management server 2 through the communication line 3. The management server 2 receives the advertisement display table and stores the advertisement display table of the automatic cash transaction apparatus 1 of each service office.

The clerk terminal 5 of the embodiment transmits the financial institution information to the advertisement control apparatus 8 of the corresponding service office in a manner similar to that in the embodiment 1.

Since the advertisement control process (FIG. 7) of the advertisement control apparatus 8 in the embodiment is similar to that in the embodiment 1, its explanation is omitted.

The operation of the advertisement displaying process of the automatic cash transaction apparatus 1 will be described hereinbelow with reference to a flowchart shown in FIG. 28 in accordance with steps starting with “SH” with respect to the withdrawal transaction process in the automatic cash transaction apparatus 1 as an example.

A routine to display the campaign information of the financial institution or the like into the under-the-process advertisement is added to the “business executing program” in the embodiment 1 and the resultant “business executing program” is stored in the ATM storing unit 22 of the automatic cash transaction apparatus 1 in the embodiment. An advertisement display notification storing area similar to that in the embodiment 1 is held in the ATM storing unit 22.

When the person in charge in the service office turns on the power source of the automatic cash transaction apparatus 1 in a manner similar to that in the embodiment 1 and the “business executing program” is activated, the ATM control unit 21 starts the advertisement displaying process and executes in parallel the advertisement display notification storing process in steps SB1 to SB4 (since the operation is similar to that in the embodiment 1, its explanation is omitted) and the transaction process accompanied with the advertisement display in steps starting with “SH” (in the embodiment, the withdrawal transaction process) in a manner similar to that in the embodiment 1.

The operation of the withdrawal transaction process accompanied with the advertisement display in the embodiment will now be described hereinbelow.

Since the operations in steps SH1 to SH3 are similar to those in steps SC1 to SC3 in the embodiment 1, their description is omitted here.

SH4 . . . The ATM control unit 21 which read out the card information attaches the apparatus number of the automatic cash transaction apparatus 1 of the read-out card information, transmits the resultant card information to the management server 2 through the intra-office LAN 4 and the communication line 3, and executes in parallel the campaign notification storing process in steps SH5 and SH6 and the operations in steps SH7 to SH9.

The management server 2 which received the card information receives the existence of the customer of the automatic cash transaction apparatus 1, reads out the customer identification ID from the received card information, searches the customer information database 40 on the basis of the customer identification ID, extracts the name of customer of the customer information of the corresponding customer, searches the campaign information database 51, and reads out the campaign information associated with the customer identification ID and the file name of the advertisement information.

The management server 2 reads out the advertisement display table of the corresponding automatic cash transaction apparatus 1 from the stored advertisement display table on the basis of the received apparatus number of the automatic cash transaction apparatus 1, recognizes the present time/date by the timer function, and extracts the file name of the advertisement information of the display timing “under-the-process” in the corresponding advertisement time zone.

When the extracted file name coincides with the file name of the read-out campaign information, the name of the customer is added into the campaign information and the resultant campaign information as a campaign notification is transmitted to the automatic cash transaction apparatus 1 of the transmitting source side through the communication line 3 and the intra-office LAN 4.

When the campaign information associated with the customer identification ID does not exist or when the file name does not coincide, a campaign notification showing “no campaign information” is transmitted.

In this case, it is also possible to construct the system in such a manner that when the automatic cash transaction apparatus 1 transmits the card information or the like to the management server 2 in step SH4, the file name of the advertisement information which is displayed is added to the under-the-process advertisement, and the management server 2 transmits the resultant advertisement to the campaign design terminal 50. Thus, the campaign design terminal 50 does not need to hold the advertisement display table of the automatic cash transaction apparatus 1 of each service office and a storage capacity of the campaign design terminal 50 can be reduced.

SH5 . . . The ATM control unit 21 of the automatic cash transaction apparatus 1 which is in the standby mode to wait for the reception of the campaign notification from the management server 2 by the parallel processes after the card information was transmitted advances to step SH6 when it receives the campaign notification. When it does not receive the campaign notification, the ATM control unit 21 continues the standby mode.

SH6 . . . The ATM control unit 21 which received the campaign notification stores the campaign notification into the advertisement display notification storing area of the ATM storing unit 22.

The reception and the temporary storage of the campaign notification are executed during the processes in steps SH7 to SH9.

Since the operations in steps SH7 to SH11 are similar to those in steps SC4 to SC8 in the embodiment 1, their description is omitted here.

SH12 . . . The ATM control unit 21 which determined that the display of the under-the-process advertisement is necessary refers to the campaign notification in the advertisement display notification storing area. When the campaign notification is the campaign information in which the customer names are added, the ATM control unit 21 determines that the display of the under-the-process advertisement of the campaign information is necessary, and step SH14 follows. If the campaign notification is “no campaign information”, it is determined that the display of the under-the-process advertisement similar to that in the embodiment 1 is necessary, and step SH13 follows.

SH13 . . . The ATM control unit 21 which determined that the display of the under-the-process advertisement is necessary displays the under-the-process advertisement display screen shown in FIG. 14 as an under-the-process advertisement in a manner similar to step SC9 in the embodiment 1.

SH14 . . . The ATM control unit 21 which determined that the display of the under-the-process advertisement for the campaign information is necessary displays the under-the-process advertisement display screen of the campaign information shown in FIG. 29 as an under-the-process advertisement onto the customer operation unit 23.

That is, the ATM control unit 21 refers to the advertisement display table in the advertisement display notification storing area of the ATM storing unit 22, simultaneously displays both of the advertisement information of the file name written in the display information of the display timing “under-the-process” in the advertisement time zone corresponding to the present time/date and the campaign information in which the customer name of the campaign notification is added onto the under-the-process advertisement display column 33, and displays the under-the-process advertisement display screen of the campaign information which displays the “return to transaction” button to return to the transaction during the advertisement display onto the customer operation unit 23.

The under-the-process advertisement for the campaign information can be sequentially displayed without limiting to the simultaneous display. As displaying order in this case, it is possible to display the display screen of the advertisement information first in a manner similar to the case of FIG. 14 or display the display screen of the campaign information first.

Thus, the names of the customers, the advertisement information of the advertiser, the campaign information such as a notice sentence or the like of the campaign of the financial institution or the like related thereto, and select buttons such as “quick consultation” button for consulting with the financial institution about the contents regarding the campaign information, “guidance by telephone” button for requesting a telephone report regarding the campaign information, “request for materials” button for requesting materials regarding the campaign information, and the like are displayed in the under-the-process advertisement display column 33 on the display screen.

The customer confirms the contents of the under-the-process advertisement and depresses his desired select button. In the case of interrupting the advertisement display and returning to the transaction, he depresses the “return to transaction” button.

The ATM control unit 21 which detected the depression of the select button by the customer sets the select button into the locking mode and temporarily stores the type of depressed select button (when the “return to transaction” button is depressed without depressing the select button, the type is set to “no selection”) into the ATM storing unit 22.

SH15 . . . The ATM control unit 21 finishes the display of the under-the-process advertisement when the display time of the display information of the display timing “under-the-process” elapses or when the depression of the “return to transaction” button by the customer is detected, and the processing routine advances to step SH16. In other cases, the processing routine is returned to step SH12 and the display of the foregoing under-the-process advertisement is continued.

Since the subsequent operations in steps SH16 and SH17 are similar to those in steps SC11 and SC12 in the embodiment 1, their description is omitted here.

SH18 . . . The ATM control unit 21 which recognized the reception of the transaction card or the like by the customer transmits the advertisement use notification to which the file name of the advertisement information displayed as an under-the-process advertisement, the number of displaying times of the advertisement information, and the type of select button depressed by the customer have been attached to the management server 2 through the intra-office LAN 4 and the communication line 3.

After that, the ATM control unit 21 finishes the withdrawal transaction process, returns to step SH1, displays the pretransaction advertisement display screen onto the customer operation unit 23, and enters a standby mode.

The operation of the advertisement displaying process of the automatic cash transaction apparatus 1 in the embodiment is executed as mentioned above.

Since the operation of the display stopping process of the automatic cash transaction apparatus 1 is similar to that in the embodiment 1, its explanation is omitted here.

The management server 2 which received the advertisement use notification from the automatic cash transaction apparatus 1 in step SH18 accumulates the number of displaying times of the advertisement information of the advertiser into the accumulation table of the number of displaying times shown in FIG. 4 in a manner similar to that in the embodiment 1 and time-sequentially records the file name of the advertisement information, the customer identification ID, and the received type of select button into a customer selection collection table (the name of the advertiser is omitted) similar to the customer reaction collection table shown in FIG. 23 in the embodiment 2.

The management server 2 totalizes the accumulation number of displaying times per advertiser in a manner similar to that in the embodiment 1, charges the advertiser the advertisement fee, and outputs the customer selection collection table onto a printed matter or the display screen of the clerk terminal 5 or the like. The clerk or the like in the head office extracts the addresses and the telephone numbers of the customers by using the customer information on the basis of the customer identification ID in the customer selection collection table and makes a guidance of the financial products or the like.

It is also possible to construct the system in such a manner that when the “quick consultation” button is depressed in step SH14, the ATM control unit 21 of the automatic cash transaction apparatus 1 which detected the depression of such a button transmits contents of the consultation to the advertisement control apparatus 8 of the service office or a monitoring terminal (not shown) and notify the person in charge or the like of such contents. Thus, the person in charge in the service office can immediately guide the customer in the financial products or the like.

As described above, according to the embodiment, in addition to the effect in the embodiment 1, the campaign design terminal transmits the campaign information associated with the pre-stored customer identification ID and the advertisement information to the automatic cash transaction apparatus displaying the advertisement information and displays the under-the-process advertisement display screen displaying both of the campaign information and the advertisement information as an under-the-process advertisement. Thus, the customer can immediately know the information of the financial products or the like related to the advertisement information and the financial institution or the like can notify the customer of the effective campaign information.

In each of the foregoing embodiments, if the advertisement time zone is switched during the display of the advertisement information, by displaying the advertisement information which is being displayed to the end irrespective of displaying conditions after the switching, an unnatural impression is not made on the customer and the number of displaying times of the advertisement information can be properly counted.

It is also possible to construct the system in such a manner that if a lack of displaying time is detected when the advertisement information is intended to be displayed, the advertisement information is not displayed.

Further, although each of the embodiments has been described with respect to the advertisement display in the case of the withdrawal transaction process as an example, the above description is also true of the case of displaying an advertisement in another transaction process such as paying transaction, transfer transaction, book-keeping transaction, or the like.

Moreover, although the embodiments have been described on the assumption that the advertisement information is the advertisement for products or the like of the advertiser, the advertisement information is not limited to the advertisement but can be their classified ad., a notification indicative of contents that they want to notify their customers, or the like.

The embodiments have also been described on the assumption that the advertisement information is displayed to the lobby display apparatus at the lobby of the service office of the financial institution or the like, the monitor in the ATM corner, or the automatic cash transaction apparatus. However, in the case of displaying the advertisement information in an unmanned booth of the automatic cash transaction apparatus of a bank or the like or the ATM corner or the like of a convenience store, even if the lobby display apparatus is omitted and the advertisement information is displayed onto the monitor and the automatic cash transaction apparatus, effects similar to those in the foregoing embodiments can be obtained.

Further, the automatic transaction apparatus for performing the advertisement display is not limited to the automatic cash transaction apparatus but the invention can be applied to any apparatus so long as it is an automatic transaction apparatus having a display screen for the customers such as a receiving terminal or the like which issues paging numbers or the like to the customers.

As many apparently widely different embodiments of the present invention can be made without departing from the spirit and scope thereof, it is to be understood that the invention is not limited to the specific embodiments thereof except as defined in the claims.

1. An advertisement display system comprising:
an automatic transaction apparatus having a display screen;
a monitor set near said automatic transaction apparatus;
an advertisement control apparatus which controls an advertisement display of said automatic transaction apparatus and said monitor; and
an advertisement operation server which holds advertisement information requested by an advertiser,
wherein said advertisement control apparatus receives said advertisement information and an advertisement display table describing a display schedule of said advertisement information from said advertisement operation server, distributes said advertisement information and said advertisement display table to said automatic transaction apparatus, displays the advertisement information, and displays said advertisement information onto said monitor on the basis of said advertisement display table.

2. An advertisement display system comprising:
an automatic transaction apparatus having a display screen;
a monitor set near said automatic transaction apparatus;
an advertisement control apparatus which controls an advertisement display of said automatic transaction apparatus and said monitor; and
an advertisement operation server which holds advertisement information requested by an advertiser,
wherein said advertisement control apparatus receives said advertisement information and an advertisement display table describing a display schedule of said advertisement information from said advertisement operation server, previously distributes said advertisement information to said automatic transaction apparatus, manages an advertisement time zone during which the advertisement information is displayed to said automatic transaction apparatus on the basis of said advertisement display table, and displays said advertisement information onto said monitor.

3. The system according to claim 1, wherein said advertisement display table includes a plurality of display timing at which the advertisement information is displayed to said automatic transaction apparatus.

4. The system according to claim 3, wherein said plurality of display timing is “before transaction selection”, “under-the-process”, and “continuous”.

5. The system according to claim 4, wherein a management server is provided for a financial institution or the like and said management server records the number of displaying times of the advertisement information displayed during the process of said automatic transaction apparatus.

6. The system according to claim 4, wherein a management server is provided for a financial institution or the like, reaction collect buttons are provided for the advertisement information which is displayed to said automatic transaction apparatus, and said management server records a type of said reaction collect button depressed by a customer during a transaction of said automatic transaction apparatus.

7. The system according to claim 4, wherein a management server is provided for a financial institution or the like, reaction collect buttons are provided for the advertisement information which is displayed to said automatic transaction apparatus, and said management server records the number of displaying times of the advertisement information displayed during the process of said automatic transaction apparatus and also records a type of said reaction collect button depressed by a customer during a transaction of said automatic transaction apparatus.

8. The system according to claim 5, wherein said management server stores the advertisement display table of said automatic transaction apparatus and campaign information of the financial institution or the like, and when said management server receives the existence of the customer of said automatic transaction apparatus, said management server refers to said advertisement display table and transmits said campaign information related to the advertisement information to said automatic transaction apparatus, and said automatic transaction apparatus displays both of said advertisement information and said campaign information.

9. The system according to claim 1, wherein said advertisement control apparatus receives an instruction for interrupting and restarting the display of the advertisement information and specific advertisement information.

10. An advertisement display system comprising:
an advertisement operation server which holds advertisement information requested by an advertiser;
an advertisement control apparatus which controls an advertisement display of a service office;
a monitor which is controlled by said advertisement control apparatus and which displays the advertisement information; and
an automatic transaction apparatus which is set near said monitor, has a display screen, and is connected to said advertisement control apparatus,
wherein said automatic transaction apparatus receives at least a part of the advertisement information that is received by said advertisement control apparatus from said advertisement operation server and displayed onto said monitor from said advertisement control apparatus and displays said advertisement information onto said display screen.

11. The system according to claim 10, wherein said advertisement control apparatus receives an advertisement display table and the advertisement information from said advertisement operation server, the advertisement information is displayed onto said monitor on the basis of said advertisement display table, and when the advertisement information is displayed onto said display screen, the advertisement display table including said part of the advertisement information to be displayed onto said monitor is received together with the advertisement information and the advertisement information is displayed.

12. The system according to claim 10, wherein said advertisement information is displayed during a process waiting time of a customer and a button to return to a transaction process is displayed on said display screen.

13. The system according to claim 10, wherein when there are a plurality of said advertisement information, advertisement select buttons to select the advertisement information are displayed on said display screen so as to be selectable.

14. The system according to claim 10, wherein when said advertisement information is displayed, reaction collect buttons to collect reactions of customers are displayed on said display screen so as to be selectable.

15. The system according to claim 14, wherein when said reaction collect button is depressed, the customer is allowed to input personal information.

16. The system according to claim 2, wherein said advertisement display table includes a plurality of display timing at which the advertisement information is displayed to said automatic transaction apparatus.

17. The system according to claim 6, wherein said management server stores the advertisement display table of said automatic transaction apparatus and campaign information of the financial institution or the like, and when said management server receives the existence of the customer of said automatic transaction apparatus, said management server refers to said advertisement display table and transmits said campaign information related to the advertisement information to said automatic transaction apparatus, and said automatic transaction apparatus displays both of said advertisement information and said campaign information.

18. The system according to claim 7, wherein said management server stores the advertisement display table of said automatic transaction apparatus and campaign information of the financial institution or the like, and when said management server receives the existence of the customer of said automatic transaction apparatus, said management server refers to said advertisement display table and transmits said campaign information related to the advertisement information to said automatic transaction apparatus, and said automatic transaction apparatus displays both of said advertisement information and said campaign information.

19. The system according to claim 2, wherein said advertisement control apparatus receives an instruction for interrupting and restarting the display of the advertisement information and specific advertisement information.

20. The system according to claim 3, wherein said advertisement control apparatus receives an instruction for interrupting and restarting the display of the advertisement information and specific advertisement information.
